(19) United States
(12) Patent Application Publication
(10) Pub. No.: US 2022/0271933 A1
(43) Pub. Date: Aug. 25, 2022

(54) SYSTEM AND METHOD FOR DEVICE TO DEVICE SECRET BACKUP AND RECOVERY

(71) Applicant: Samsung Electronics Co., Ltd., Suwon-si (KR)

(72) Inventors: Xun Chen, Freemont, CA (US); Jianwei Qian, Bensenville, IL (US); Fanny F. Wong, Belmont, CA (US); Peter King, San Mateo, CA (US); Sylvia Leung, San Jose, CA (US)

(21) Appl. No.: 17/538,451

(22) Filed: Nov. 30, 2021

Related U.S. Application Data
(60) Provisional application No. 63/151,184, filed on Feb. 19, 2021.

(51) Int. Cl. H04L 9/08; G06F 21/64; H04L 9/32

(52) U.S. Cl. CPC H04L 9/0897; H04L 9/085; G06F 21/64; H04L 9/3236; H04L 63/205

(57) ABSTRACT

A method executed by a first electronic device (ED1) includes splitting a selected secret for backup into a plurality of N secret shares in a trusted execution environment (TEE) of the ED1. The method includes transferring, via the transceiver over a short-range transmission, the N secret shares to N trustee devices, by transferring each secret share from among the N secret shares to a different trustee device from among the N trustee devices. Each secret share is configured to cause the trustee device to store the secret share in a TEE of a trustee device upon receipt by the trustee device. The method includes receiving, from the trustee device, one of an acknowledgement confirming the transferred secret share is stored in the TEE of the trustee device or an error warning the transferred secret share is not stored in the TEE of the trustee device.

### CROSS-REFERENCE TO RELATED APPLICATIONS AND CLAIM OF PRIORITY

The present application claims priority to U.S. Provisional Patent Application No. 63/151,184, filed on Feb. 19, 2021. The content of the above-identified patent document is incorporated herein by reference.

### TECHNICAL FIELD

This disclosure relates generally to data backup and recovery. More specifically, this disclosure relates to a system and method for device to device secret backup and recovery.

### BACKGROUND

End users usually have various types of confidential data, can be referred to as “secrets,” including but not limited to the following: (i) login credentials (for example, username and password and/or portable authentication tokens), such as for a SAMSUNG account or WiFi hotspot or bank account; (ii) text phrases, cryptocurrency wallet recovery phrases; and (iii) encryption keys (for example, cryptocurrency keys or private keys). These secrets are so important that losing them will be very costly to the owner of the secrets. Ideally, a user would be able to backup and recover such information in a way to minimize the risk of losing the secret or its concealment.

### SUMMARY

This disclosure provides a system and method for device to device secret backup and recovery.

In a first embodiment, a method executed by a first electronic device is provided. The method includes splitting a selected secret for backup into N secret shares in a trusted execution environment (TEE) of the first electronic device. The method includes transferring, via the transceiver over a short-range transmission, the N secret shares to N trustee devices, by transferring each secret share from among the N shares to a different trustee device from among N trustee devices. Each secret share is configured to, when received by a trustee device, cause the trustee device to store the secret share in a TEE of the trustee device. The method includes receiving, from the trustee electronic device, one of an acknowledgement confirming the transferred secret share is stored in the TEE of the trustee electronic device or an error warning the transferred secret share is not stored in the TEE of the trustee electronic device.

In a second embodiment, an electronic device is provided. The electronic device functions as a source electronic device, and is referred to as a “source/recovery electronic device” when additionally functioning as a recovery electronic device. The electronic device includes a transceiver, a processor, and a memory. The processor is coupled to the transceiver and to the memory. The memory stores instructions that, when executed by the processor, cause the processor to perform device to device secret backup and recovery processes. Particularly, the instructions cause the processor to split a selected secret for backup into N secret shares in a trusted execution environment (TEE) of the electronic device. The instructions also cause the processor to transfer, via the transceiver over a short-range transmission, the N secret shares to N trustee devices, by transferring each secret share from among the N secret shares to a different trustee device from among the N trustee devices. Each secret share is configured to, when received by a trustee device, cause the trustee device to store the secret share in a TEE of the trustee device. The instructions further cause the processor to receive, from the trustee electronic device, one of an acknowledgement confirming the transferred secret share is stored in the TEE of the trustee electronic device or an error warning the transferred secret share is not stored in the TEE of the trustee electronic device.

In a third embodiment, a trustee electronic device is provided. The trustee electronic device includes a transceiver, a processor, and a memory. The transceiver is configured to perform short-range communications. The processor is coupled to the transceiver and to the memory. The memory stores instructions that, when executed by the processor, cause the processor to perform device to device secret backup and recovery processes. Particularly, the instructions cause the processor to establish a short-range communications connection to a source electronic device. The instructions also cause the processor to receive a secret share from a trusted execution environment (TEE) of the source electronic device over the short-range communication connection, the secret share being one from among N secret shares generated by the source electronic device. The instructions also cause the processor to check whether the received secret share is secure. The instructions also cause the processor to, in response to determining the received secret share is secure, store the secret share in a TEE of the trustee electronic device and transmit an acknowledgement to the source electronic device confirming the received secret share is stored in the TEE of the trustee electronic device. The instructions further cause the processor to, in response to determining the received secret share is not secure, transmit an error signal to the source electronic device warning the received secret share is not stored in the TEE of the trustee electronic device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIG. 2 illustrates an example electronic device in accordance with an embodiment of this disclosure;

FIGS. 3A-3B illustrate an example electronic device in accordance with an embodiment of this disclosure;

FIG. 4 illustrates an example block diagram of setting a secret, generating shares of the secret, and transferring the shares from a source device to a plurality of trustee devices in accordance with an embodiment of this disclosure;

FIG. 5 illustrates an example block diagram of recovering a secret from a number of shares that are transferred from a number of trustee devices to a recovery device in accordance with an embodiment of this disclosure;

FIG. 6 illustrates an example block diagram of a main electronic device and a trustee electronic device performing device-to-device secret backup in accordance with an embodiment of this disclosure;

FIG. 7 illustrates an example block diagram of a main electronic device and a trustee electronic device performing device-to-device secret recovery in accordance with an embodiment of this disclosure;

FIGS. 8A and 8B illustrate example user interfaces for setting a secret and generating shares of the secret in accordance with an embodiment of this disclosure;

FIGS. 9A-9E illustrate example user interfaces for device-to-device secret backup to multiple trustee electronic devices in accordance with an embodiment of this disclosure;

FIGS. 10A-10D illustrate example user interfaces for device-to-device secret recovery from multiple trustee electronic devices in accordance with an embodiment of this disclosure;

FIGS. 11A-11C illustrate example user interfaces for device-to-device secret backup to a second electronic device having a same owner as the main electronic device in accordance with an embodiment of this disclosure;

FIGS. 12A-12D illustrate example user interfaces for device-to-device secret recovery from a second electronic device having a same owner as the main electronic device in accordance with an embodiment of this disclosure;

FIGS. 13A-13C illustrates a process for device-to-device secret backup in accordance with an embodiment of this disclosure;

FIG. 14 illustrates a process for pairing a source/recovery electronic device to a trustee electronic device in accordance with an embodiment of this disclosure;

FIG. 15 illustrates a process for device-to-device secret recovery in accordance with an embodiment of this disclosure; and

FIGS. 16A-16B illustrate a process for device-to-device secret backup and recovery in an electronic device in accordance with an embodiment of this disclosure.

### DETAILED DESCRIPTION

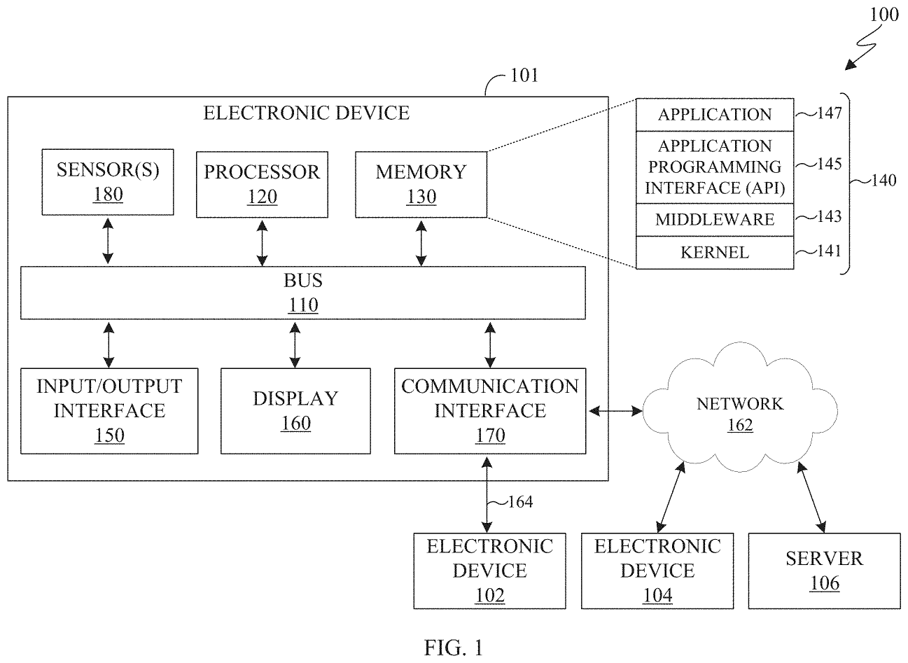

FIGS. 1 through 16B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged wireless communication system.

General data backup solution usually makes one or more duplicated copies of the original data and stores the duplicated copies in a separate place (e.g., in remote media such as email or a storage in cloud storage device or in local media. Examples of local media include paper, a board (e.g., chalkboard, white-board for markers, cork board), computer storage on a mobile device, personal computer, external hard drive and etc. Applying this technique of storing the duplicated copies in a place separate from the original data as a technique of backing-up a secret is problematic.

As a first problem for backing up, making duplicated copies will always increase the risk of data being hacked/exposed to unauthorized parties. However, the more copies, the better redundancy. Therefore, techniques of backing-up a secret involve a conflict between security and redundancy, which conflict is a common problem for both remote backup and local backup.

As a second problem for backing up, remote backup and recovery often requires the owner of the original data (which may include customer's confidential data that belongs to a customer of a cloud computing service) to trust the remote server. As in most cases, the remote server has the access to the backup, and in some cases, the owner of the remote server has access to data stored on the remote server. Such access enables a malicious insider (e.g., an employee for the owner of the remote server) to view and expose the customer's confidential data. A remote server is often a popular target of hackers as it stores a lot of data. Any hack or data breach on the server could result in the leakage of backed-up customer's confidential data, and it is practically impossible to track where the leaked secret flows. In some scenarios, remote backup and recovery services are provided by a remote server owned by a corporation that ceases to offer (e.g., terminates) the remote backup and recovery services or that experiences a life cycle end (e.g., goes out of business). Such termination of remote backup and recovery services causes an owner of a secret to no longer have control to protect the backed-up secret from an undesirable successor of the corporation.

As a third problem for backing up, remote backup and recovery often requires availability of network (e.g., Internet access). However, transferring customer's confidential data could be eavesdropped or intercepted, or tampered by man-in-the-middle attacks. Additionally, the network might not always be available.

As a fourth problem for backing up, backup to and recovery from remote storage usually requires a credential, such as a cloud account ID and password, to control or limit access to the referred storage. This credential usually requires the user (e.g., customer of cloud computing service) to memorize, which adds additional burdens to the user.

Embodiments of the present disclosure split a user-selected secret for backup into a plurality of shares within a trusted execution environment (TEE); and transfer, via a transceiver on the device over short-range transmission, the plurality of shares to a plurality of trustee devices. Each share of the secret is transferred to a different trustee device to be stored in the trustee device's trusted execution environment (TEE). In certain embodiments of this disclosure, an electronic device that is owned by a trustee is interchangeably referred to as a trustee device, a trustee's device, or a trustee electronic device.

Regarding the conflict between security and redundancy, certain embodiments of this disclosure provide a custom level of security. The backup and recovery of the data is well protected such that it cannot be accessed by (or exposed to) unauthorized entities. Embodiments of this disclosure also provide a custom level of redundancy. The backup of data has enough redundancy such that the recovery is always available even when some data backup is inevitably damaged and/or lost.

In certain embodiments of this disclosure, a device-to-device (D2D) system performs backup and recovery of a secret without using a remote server. According to embodiments of this disclosure, the system includes a secret owner's device (called as “source device” in backup and “recovery device” in recovery) and a set of trustee devices located within a physical proximity to the secret owner's device. The recovery device could be the same device as the source device, or a different device than the source device. For example, when user loses the source device, the user might need to recover the secret to a new device as recovery device. Each device (source, recovery, and trustee) has a processor supporting a trusted execution environment (TEE), a biometric authenticator, a data I/O interface and a short-range communication component. The devices can be easily and physically accessed by the secret owner according to the device owners' permission and awareness.

In certain embodiments, device-to-device secret backup and recovery processes include performing actions to securely pair the source/recovery device with trustee device using a key negotiated between TEE of source/recovery device and TEE of trustee device via short-range communication. In order to backup a secret, the source device receives (e.g., from user input) a secret into its TEE, splits the secret into a predefined number of pieces called as secret shares within source device's TEE, and transfers the secret shares to multiple trustee devices for storage within the trustee device's TEE. In order to recover the secret, a recovery device requests secret shares from multiple trustee devices; identifies and removes the incorrect secret shares until a predefined number of correct secret shares are received; and reconstructs the secret from the predefined number of correct secret shares.

In certain embodiments, in order to securely pair the source/recovery device with trustee device, the user of the source/recovery device designates a set of devices as trust devices; and the source/recovery device and each of the trustee devices establish a trustor-trustee relationship via short-range device-to-device communication. User authentication is required at the beginning of device pairing. The source/recovery device maintains a list of trustee devices. Each trustee device maintains a list of corresponding source/recovery devices that are designated as a trustor. Accordingly, embodiments of this disclosure prevent the owners of the source/recovery device and trustee device from being burdened with memorizing who are the trustees and trustor of each secret. In certain embodiments of this disclosure, a biometric authenticator performs the user authentication, which reduces the memorization burden of the owners of the source/recovery device and trustee device, who are no longer required to remember a username, password, or personal identification number (PIN) to interact with backup and recovery processes.

In certain embodiments, a secret backup from one source device to multiple trustee device (1-to-multiple backup scenario) is enabled. A secure device pairing can be completed before a secret backup is initiated. The secret is split into several pieces of secret shares such that a minimum number of secret shares are required to combine in order to recover the original secret. Each secret share is encrypted by the key only known by the user of the source device. The checksums of all shares and a signature is appended to each share. The user of the source device designates a trustee device for each secret share. The information of all these designations is appended to each share. The shares are then transferred to their designated trustee devices. Each trustee device encrypts the received secret share using a key known only by trustee device's owner. The transfer of the share occurs via short-range device-to-device communication.

In certain embodiments, a secret recovery from multiple trustee device to a recovery device (1-to-multiple recovery scenario) is enabled. A secure device pairing can be completed before secret recovery. The recovery device requests a secret share from a trustee device selected by a user of the recovery device. The trustee device decrypts the secret share and transfers it to the recovery device via short-range device-to-device communication. The recovery device reads the list of designations among secret shares and trustee devices from the appended info, and such designation info will be provided to user. When receiving a secret share from a trustee device, the recovery device checks if it has received the required minimum number of secret shares for recovering the original secret. If the minimum number has not been received, the recovery device continues to request a secret share from another trustee device. If the minimum number has been received, the source device performs a majority vote to determine the correct hash information of secret shares. If all received secret shares have the correct hashes, the recovery device reconstructs (e.g., tries to recover) the original secret. If some secret shares have incorrect hashes, the recovery device removes those incorrectly-hashed secret shares, and continues to request a secret share from another trustee device. The recovery device repeats this process until either the secret is recovered or no more trustee devices remain, in which case the recovery fails.

Embodiments of this disclosure provide on-device key management, which includes deriving (e.g., creating or generating) a key pair from user authentication in the TEE of the device. By utilizing the derived key pair, the source device and one trustee device negotiate a communication encryption key (K_{C}) to establish a short-range communication channel between each other. The on-device key management of this disclosure does not require a key management server.

Embodiments of this disclosure provide confidentiality. Data stored in on-device storage is always encrypted by the key derived from user authentication. Data being communicated between a source/recovery device and a trustee device is always encrypted by the communication encryption key K_{C}. Only the original secret owner can decrypt the secret share and secret.

As introduced above, embodiments of this disclosure provide customized security. An original secret is split into a number (N) of non-identical secret shares and shares are distributed into multiple devices. A number (K) of trustee devices are required to recovery secret. If the value of K is two (2), then a 1-to-2 scenario occurs, but if the value of K is one (1), then a 1-to-1 scenario occurs. Thus, the original secret is only exposed if at least K secret shares are exposed from K trustee devices. By requiring user authentication on both the source device and trustee devices, the risk of exposing secret shares is reduced. Short-range communication is adopted to avoid man-in-the-middle attacks and thereby avoid the need of a CA.

As introduced above, embodiments of this disclosure provide customized redundancy. The secret share has redundancy such that the damage to a user-configurable number of secret shares for any reason can be tolerated. Embodiments of this disclosure provide a UI to guide user through the setup process, to configure various settings, and to show the meta information about the backup and recovery, such as time, trust device list, etc.

### Trusted Execution Environment

An electronic device, according to embodiments of the present disclosure, can implement a trusted execution environment (TEE), such as in a secure area of a main processor and a secure area under control of an operating system. A TEE can act as an isolated execution environment to provide security features such as isolated execution, integrity of applications executing with the TEE, along with confidentiality of application assets. The TEE may be a secure operating environment and may include a hardware component and a software component (e.g., an ARM TRUSTZONE operating environment). In general, the TEE may execute secure applications, with limited access to other elements and components of the electronic device. Similarly, non-secure applications executing outside the trusted execution environment have limited or no access to secure applications executing inside the trusted execution environment.

In various disclosed embodiments, the TEE can include one or more trusted applications (“trusted apps”). The trusted apps in the TEE can include device authenticator trusted apps that collect user authentication data. The trusted apps in the TEE can include an authentication trusted app that performs such functions as collecting and integrating user authentication data and verifying its validity. The trusted apps in the TEE can include payment trusted apps that, when properly authorized, perform payment processing according to requirements of a financial service provider (for example, a bank, credit card payment processors, or other financial service providers). The trusted apps in the TEE can include trusted device-to-device (D2D) secret backup and recovery apps that, when properly authorized, (i) backups a secret with sufficient security such that the secret cannot be accessed by or exposed to unauthorized entities (for example, unauthorized persons) and with sufficient redundancy such that recovery is available when some data backup is inevitably damaged and/or lost and; and (ii) recovers the backed-up secret from an external device. The trusted apps in the TEE can include other trusted apps, such as key storage trusted apps, and others.

FIG. 1 illustrates an example communication system 100 in accordance with an embodiment of this disclosure. The communication system 100 includes electronic devices 101, 102, 104 in accordance with this disclosure. The embodiment of the communication system 100 shown in FIG. 1 is for illustration only. Other embodiments of the network configuration 200 could be used without departing from the scope of this disclosure.

According to embodiments of this disclosure, an electronic device 101 is included in the communication system 100. The electronic device 101 can include at least one of a bus 110, a processor 120, a memory 130, an input/output (I/O) interface 150, a display 160, a communication interface 170, and one or more sensors 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), a graphics processor unit (GPU), an application processor (AP), or a communication processor (CP). The processor 120 is able to perform control on at least one of the other components of the electronic device 101 and/or perform an operation or data processing relating to communication. In certain embodiments, the processor 120 performs device-to-device secret backup and recovery processes as described herein.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted as an operating system (OS). Different portions of memory 130 and/or a memory in processor 120 can be designated for use as a trusted execution environment (TEE).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 includes one or more applications for trusted device-to-device (D2D) secret backup and recovery functions as discussed below. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

In some embodiments, the electronic device 101 further includes one or more speakers that convert electrical signals into sound. The speakers can be housed within a housing of the electronic device 101. The speakers can be connected to the bus 110 directly or indirectly through an intermediate connection to the I/O interface 150.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as an electronic device 102, a third electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals, such as images.

The wireless communication is able to use at least one of, for example, long term evolution (LTE), long term evolution-advanced (LTE-A), 5th generation wireless system (5G), millimeter-wave or 60 GHz wireless communication, Wireless universal serial bus (USB), code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a USB, high-definition multimedia interface (HDMI), recommended standard 132 (RS-232), or plain old telephone service (POTS). The network 162 or 164 includes at least one communication network, such as a computer network (like a local area network (LAN) or wide area network (WAN)), Internet, or a telephone network.

The communication interface 170 is able to set up device-to-device (D2D) communication between the electronic device 101 and an external electronic devices 102 and 104. The D2D communication can be Bluetooth Low Energy (BLE) communication, near-field communication, or other short-range communication.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. The sensor(s) 180 can include an audio sensor, such as a microphone, that convert sound into electrical signals. Example microphones include a dynamic microphone, a condenser microphone, a piezoelectric microphone, or the like. In addition, the sensor(s) 180 can include a control circuit for controlling at least one of the sensors included here. Any of these sensor(s) 180 can be located within the electronic device 101.

The sensor(s) 180 can be used as input devices for user authentication, such as implementing a touchscreen or buttons for receiving passcodes, PINs, or patterns, a fingerprint sensor for scanning a user's fingerprint, a camera for iris or facial recognition, and the like.

The external electronic devices 102 and 104 can include the same or similar components 110-180 as the electronic device 101 (or a suitable subset thereof). The electronic device 101 can be directly connected with the second electronic device 102 to communicate with the second electronic device 102 without involving with a separate network.

The external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the external electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as external electronic devices 102 and 104 or server 106) to perform at least some functions associated therewith. The other electronic device (such as external electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic devices 102 and 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. In certain embodiments, the server 106 performs the natural language processing. In certain embodiments, the server 106 performs various services, including secure data transfer with a cloud storage provider or single sign-on (SSO) services.

Although FIG. 1 illustrates one example of a communication system 100 including an electronic device 101, various changes may be made to FIG. 1. For example, the communication system 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

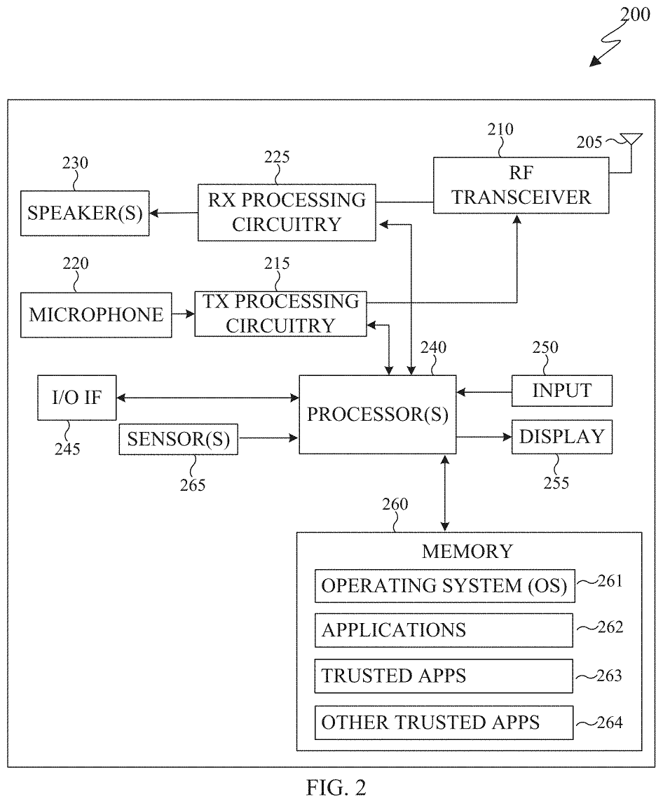

FIG. 2 illustrates an example electronic device 200 in accordance with an embodiment of this disclosure. The electronic device 200 can be similar to any of the electronic devices 101-104 of FIG. 1 and can include the same or similar components 110-180 as the electronic devices 101-104 of FIG. 1.

As shown in FIG. 2, the electronic device 200 includes an antenna 205, a radio frequency (RF) transceiver 210, transmit (TX) processing circuitry 215, a microphone 220, and receive (RX) processing circuitry 225. The electronic device 200 also includes a speaker 230, a main processor 240, an input/output (I/O) interface (IF) 245, a keypad 250, a display 255, and a memory 260. The memory 260 includes a basic operating system (OS) program 261, one or more applications 262, and one or more trusted applications 263 (also referred to as “trusted apps”). The trusted apps 263 include trusted device-to-device (D2D) secret backup and recovery apps, which enable performance of device-to-device secret backup and recovery processes according to this disclosure. Although illustrated separately, the trusted apps 263 includes other trusted apps 264 in addition to the trusted D2D secret backup and recovery apps. For simplicity, reference number 263 will interchangeably refer generally to trusted apps and specifically to the trusted D2D secret backup and recovery app. For short, the trusted D2D secret backup and recovery app 263 is also referred to as the “secret vault” app.

The RF transceiver 210 receives, from the antenna 205, an incoming RF signal transmitted by an eNB of the communication system 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the main processor 240 for further processing (such as for web browsing data).

The TX processing circuitry 215 receives analog or digital voice data from the microphone 220 or other outgoing baseband data (such as web data, e-mail, or interactive video game data) from the main processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna 205.

The main processor 240 can include one or more processors or other processing devices and execute the basic OS program 261 stored in the memory 260 in order to control the overall operation of the electronic device 200. For example, the main processor 240 could control the reception of forward channel signals and the transmission of reverse channel signals by the RF transceiver 210, the RX processing circuitry 225, and the TX processing circuitry 215 in accordance with well-known principles. In some embodiments, the main processor 240 includes at least one microprocessor or microcontroller.

The main processor 240 is also capable of executing other processes and programs resident in the memory 260. The main processor 240 can move data into or out of the memory 260 as required by an executing process. In some embodiments, the main processor 240 is configured to execute the applications 262 based on the OS program 261 or in response to signals received from eNBs or an operator. The main processor 240 is also coupled to the I/O interface 245, which provides the electronic device 200 with the ability to connect to other devices such as laptop computers and handheld computers. The I/O interface 245 is the communication path between these accessories and the main processor 240.

The main processor 240 is also coupled to one or more input devices 250 (e.g., keypad) and to one or more output devices 255 (e.g., electronic display illustrated as “DISPLAY”). The operator of the electronic device 200 can use a keypad input device 250 to enter data into the electronic device 200. The output device 255, as a display, may be a liquid crystal display or other display capable of rendering text and/or at least limited graphics, such as from web sites.

The memory 260 is coupled to the main processor 240. Part of the memory 260 could include a random access memory (RAM), and another part of the memory 260 could include a Flash memory or other read-only memory (ROM).

As described in more detail below, the main processor 240 accesses instructions (e.g., computer program code) stored in the memory 260, and by executing the instructions, performs device-to-device secret backup and recovery processes according to this disclosure.

Although FIG. 2 illustrates one example of an electronic device 200, various changes may be made to FIG. 2. For example, various components in FIG. 2 could be combined, further subdivided, or omitted and additional components could be added according to particular needs. As a particular example, the main processor 240 could be divided into multiple processors, such as one or more central processing units (CPUs) and one or more graphics processing units (GPUs). Also, while FIG. 2 illustrates the electronic device 200 configured as a mobile telephone or smartphone, UEs could be configured to operate as other types of mobile or stationary devices.

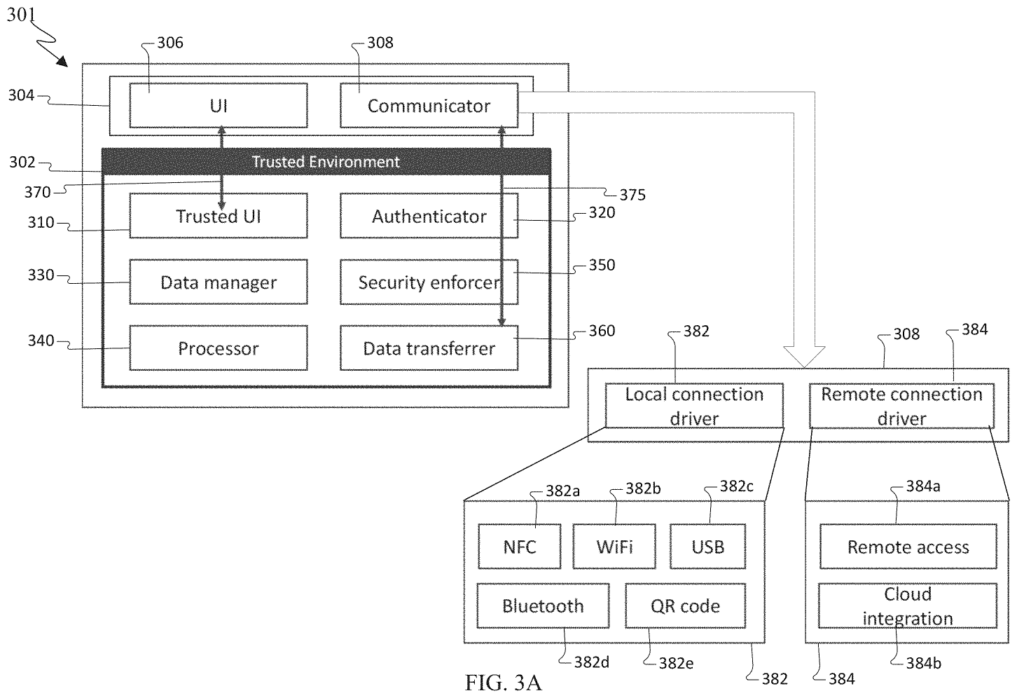

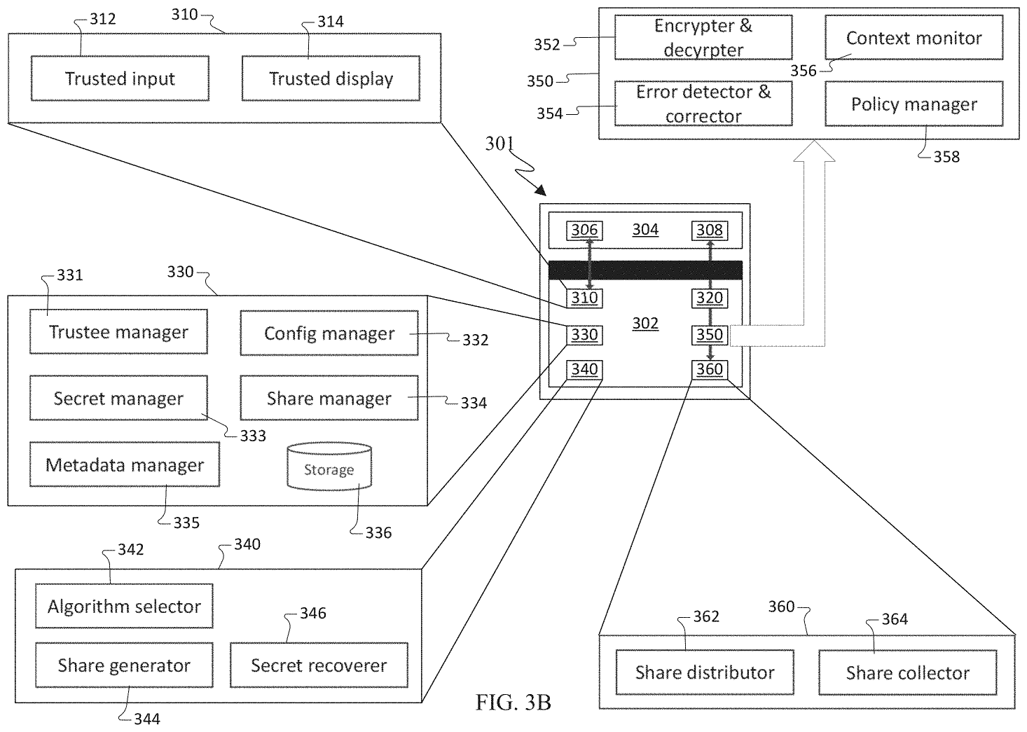

FIGS. 3A-3B illustrate an example electronic device 301 in accordance with an embodiment of this disclosure. The electronic device 301 can be similar to any of the electronic devices 101-104 of FIG. 1 or electronic device 200 of FIG. 2. That is, the electronic device 301 can include the same or similar components 110-180 as the electronic devices 101 of FIG. 1 and can include the same or similar components 205-265 as the electronic device 200 of FIG. 2.

The electronic device 301 includes a trusted execution environment (TEE) 302 and a non-secure execution environment 304. As examples, the TEE 302 can be implemented using ARM TRUSTZONE technology or INTEL software guard extensions (SGX).

The components of the electronic device 301 that are outside of the TEE 302 are included in the non-secure execution environment 304. The non-secure execution environment 304 includes a user interface 306 and a communicator 308. The user interface 306 is executed (for example, runs) outside the trusted environment. The user interface 306 represents the output device 255 of FIG. 2 or electronic display 160 of FIG. 1. The communicator 308 provides secure device connection functionalities, handshakes, and sets up (for example, builds) end-to-end secure channels with external devices.

The communicator 308 includes a local connection driver 382, which provides secure communication with devices in proximity to the electronic device 301. The local connection driver 382 can perform short-range communication using near field communication (NFC) 382a, WiFi 382b, USB connection 382c, BLUETOOTH paired connection 382d, or QR code 382e. The communicator 308 includes a remote connection driver 384, which provides secure communication with a remote machine (for example, server 106) or cloud services. The remote connection driver 384 enables remote access 384a, allowing the electronic device 301 to perform secure data transfer with a remote device. In a non-limiting example, the owner of electronic device 301 is also the owner of a work personal computer (PC), and remote connection driver 384 enables electronic device 301 to perform secure data transfer with the work PC via Secure Shell Protocol (SSH), or with a friend's device (for example, third electronic device 104) in a different city. The remote connection driver 384 enables cloud integration 384b, allowing the electronic device 301 to perform secure data transfer with a cloud storage provider, such as DROPBOX.

The TEE 302 includes a trusted user interface 310, an authenticator 320, a data manager 330, a processor 340, a security enforcer 350, and a data transferer 360. More particularly, within TEE 302 are trusted apps, which can be the same as or similar to the secret vault app 263 of (FIG. 2). FIG. 3B, shows additional details about the TEE 302, such as components of the trusted user interface 310, data manager 330, processor 340, security enforcer 350, and data transferer 360.

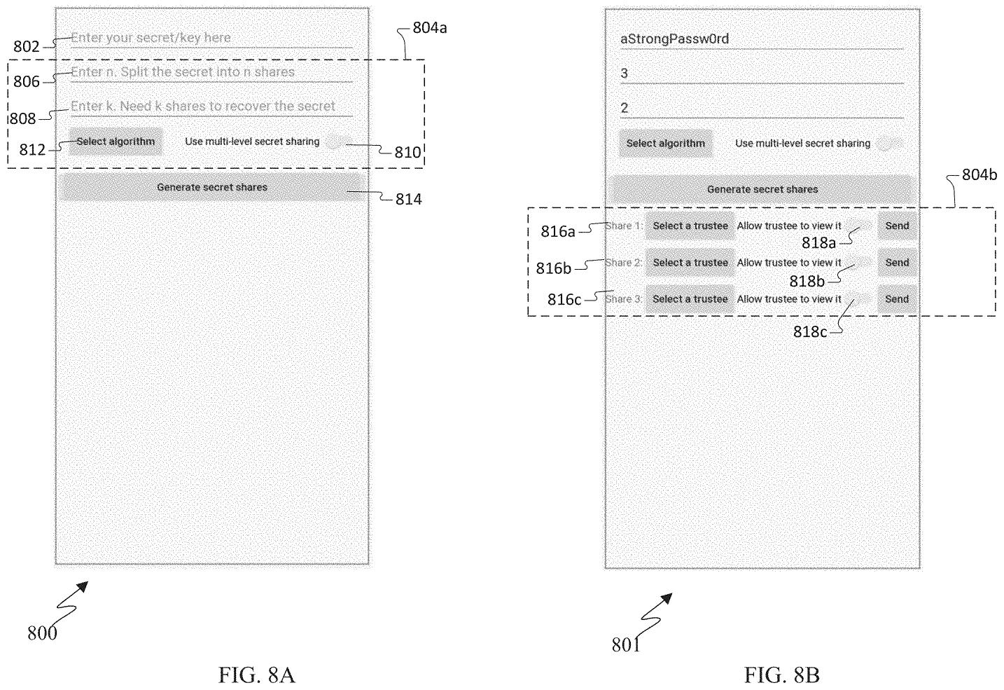

The trusted user interface 310 is a user interface running in the trusted environment. For simplicity, the trusted user interface 310 shown in FIG. 3A and its components shown in FIG. 3B will be described together, and will not be duplicated with the description of FIG. 3B further below. The trusted user interface 310 includes a trusted input 312 (FIG. 3B) and a trusted output 314 (FIG. 3B). The trusted user interface 310 receives input (for example, a secret, configuration settings, metadata, or remarks) through the trusted input 312, such as user input through an input device 250. The trusted input 312 allows the user to provide a secret by typing on a keypad or reading a file (i.e., selecting a file to be read by the processor 340), or importing the secret from an app. That is, the trusted input 312 is not limited to receiving user input via a human-to-machine interface, but also can receive data input that is read from computer memory. The trusted input 312 enables the user to choose configuration settings 804a-804b (FIG. 8A-8B), which can also be referred to as configuration selections.

The trusted user interface 310 provides various trusted user interfaces that prompt and enable a user to provide input to the trusted input 312. More particularly, the trusted display 314 outputs trusted user interfaces through the user interface 306, for example, by calling (as illustrated by the bidirectional call arrow 370) the user interface 306 for rendering. The trusted display 314 allows the recovered secret to be shown to the user or to be exported to an app.

When the user initiates a secret backup through UI 306, UI 306 calls trusted input 312 to obtain input from the user and forwards the input to other components in the TEE 302. When the user initiates a secret recovery through UI 306, UI 306 calls the trusted input 312 to obtain the user request (for example, a user-selection of which secret to be recovered). After the secret is recovered in TEE 302, the trusted display 315 shows the recovered secret to the user or exports the recovered secret to an app.

The authenticator 320 can include device authenticator trusted apps that collect user authentication data. The user authentication data can include biometric data such as fingerprints, iris images, facial images, or a combination thereof. The user authentication data can include gatekeeper data such as previously-registered/reference PINs, passcodes, patterns, and others. The authenticator 320 authenticates the user's identity to ensure that authorization from the user has been received.

The data manager 330 manages trustees' information, user configurations, information about secrets, information about shares, and other metadata. The processor 340 can be a secure area of a main processor (for example, processor 120 of FIG. 1 or main processor 240 of FIG. 2) and is referred to as the TEE on the device processor. The processor 340 executes the trusted apps within the TEE 302, providing computing functionalities and executing algorithms. The security enforcer 350 protects security for secrets and shares, including confidentiality and integrity. The data transferer 360 determines distribution of shares and collection of shares. More particularly, the data transferer 360 calls (as illustrated by the bidirectional call arrow 375) the communicator 308 to transfer shares.

Now refer to FIG. 3B, which illustrates additional details about the TEE 302, including components of the trusted user interface 310, data manager 330, processor 340, security enforcer 350, and data transferer 360.

The data manager 330 includes trustee manager 331, configuration manager 332, secret manager 333, share manager 334, metadata manager 335, and storage 336. The trustee manager 331 manages information about the user's trustees and the trustees' devices. For example, trustee manager 331 of a source/recovery device maintains a list of trustee devices. Also, the trustee manager 331 of each trustee device maintains a list of corresponding source/recovery devices.

The configuration manager 332 manages user-adjustable configuration settings for each secret. The configuration settings can be applied to a group of secrets such that each secret has the same configuration settings. Alternatively, configuration settings can be applied to each secret, individually, such that configuration settings applicable to one secret may differ from the configuration applicable to another secret. For each secret, the configuration settings include the number of shares to distribute (herein defined as “n”), the number of shares needed for recovery (herein defined as “k”), and a trustee grouping. As a non-limiting example, a trustee grouping may include two external devices (102 and 104), such as, one family's device and one friend's device. That is, the family's device (102) can be owned by the family of the owner of the electronic device 301, which family member may cohabitate with the owner of the electronic device 301. The friend's device (104) can be owned by a friend of the owner of the electronic device 301, which friend may live in a different city or in the same neighborhood as the owner of the electronic device 301. As another non-limiting example, a trustee grouping may include one external device (102), such as, an old smartphone or old personal laptop or work PC that is owned by the same owner of the electronic device 301.

The secret manager 333 manages information about each secret that is backed up, including but not limited to: (i) create time; (ii) usage; (iii) owner of secret; and (iv) trustees (namely, who and what devices store the shares of this secret). The creation time is a date and timestamp of when a secret was backed up. The usage identifies the purpose of the secret, for example, usage for bank account logins or usage for crypto wallet key mnemonic paraphrase. The owner of electronic device 301 might be helping someone else to back-up their secret. Accordingly, for each secret, the owner of the secret identifies an owner, which distinguishes the owner of the electronic device 301 from other owners of secrets (e.g., friends, family, co-workers, neighbors, confidants of the electronic device 301).

The share manager 334 manages information about each share of each secret, including but not limited to: (i) receive time that indicates when the share was received to this electronic device 301; (ii) owner of the share; and (iii) sender of the share. The share may be sent from the owner or may be forwarded by another trustee. The owner of the share is the owner of the secret from which the share was generated.

The metadata manager 335 manages all other metadata including but not limited to: (i) trustees; (ii) data transfer log; (iii) activity log; and (iv) statistics. The trustees include a list of paired trustees and the trustee's device information. The data transfer log includes timestamps and connection types of each interaction with other devices. The activity log includes a logbook or register of which app accessed the secret and a date/timestamp of when the secret was access by the app. The statistics include a number of trustees, a number of secrets, a number of shares on each trustee's device, and the like.

The storage 336 provides secure data storage for shares, configuration settings, and the like. In certain embodiments, the storage 336 is a database.

The processor 340 includes an algorithm selector 342, a share generator 344, and a secret recoverer (“secret recovery module”) 346. The algorithm selector 342 selects which algorithms to use for secret backup and recovery according to a security policy. Example security policies include a Shamir secret sharing, multi-signature, and the like. Any algorithm can be selected if the algorithm supports all four of the following: (1) backup a secret to N trustees; (2) no trustee can see (i.e., access or be exposed to a raw/non-encrypted version of) the secret; (3) any subset of K trustee devices (wherein K≤N) that store a share of the secret can work together to recover or reconstruct the secret from K secret shares; and (4) any j trustees (where j is fewer than K trustee devices (j<K)) that store a share of the secret cannot recover the secret by working together or alone.

The share generator 344 generates shares for a given secret by following the user-adjustable configuration settings and by executing the selected algorithm, which is selected by the algorithm selector 342. Analogously, the secret recovery module 346 reconstructs a secret from shares by following the user-adjustable configuration settings and by executing the selected algorithm, which is selected by the algorithm selector 342.

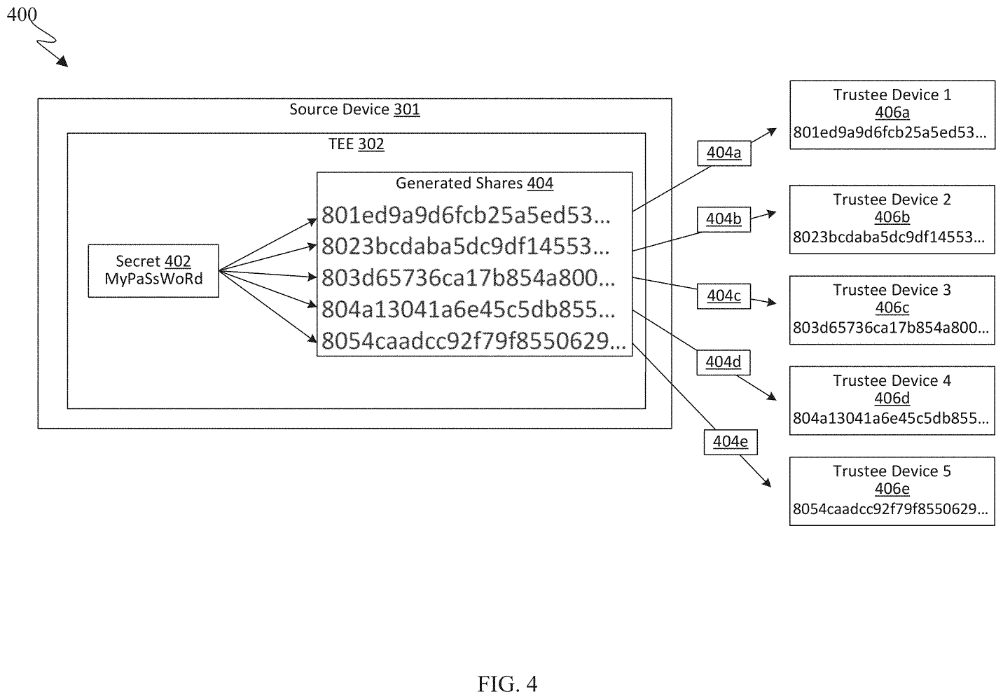

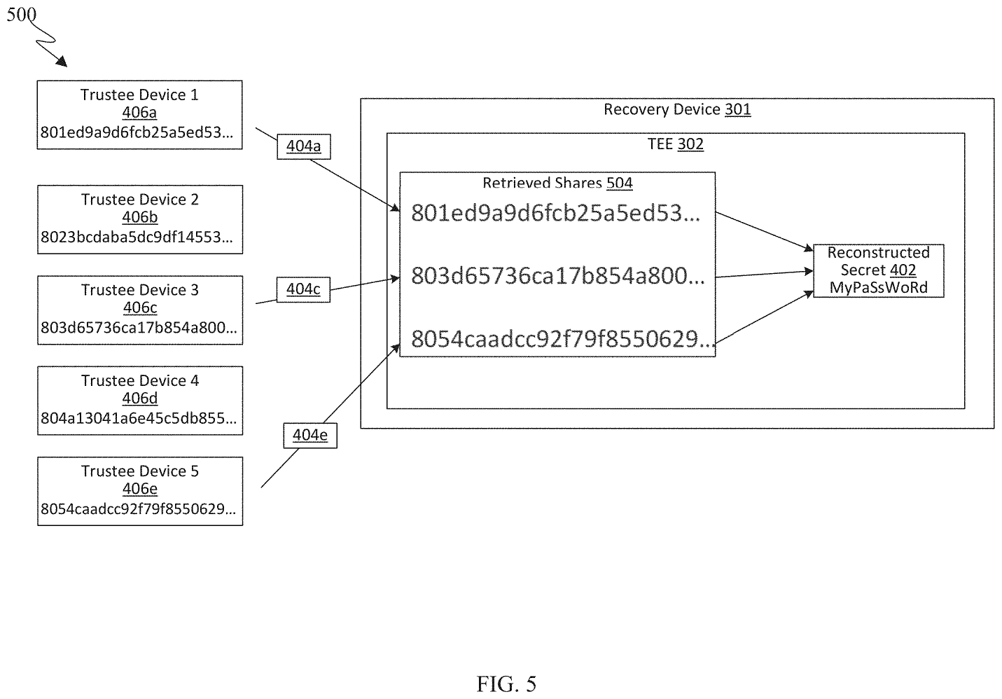

In a non-limiting example, the share generator 344 generates five (5) shares according to user-adjustable configuration settings that specify n=5 and k=3, as shown in FIG. 4, which is described more particularly below. In furtherance of this non-limiting example, the secret recovery module 346 reconstructs a secret from three (3) shares retrieved from three trustee devices, as shown in FIG. 5, which is described more particularly below.

The security enforcer 350 includes encryption/decryption module 352 (illustrated as encrypter & decrypter), error detector and corrector 354, context monitor 356, and policy manager 358. The encryption/decryption module 352 ensures only the TEE 302 can see or access the data (i.e., secrets, shares, configuration settings, and the like) used for device-to-device secret backup and recovery processes. That is, the encryption/decryption module 352 ensures such that the non-secure execution environment 304 and no other unauthorized entity outside the TEE 302 can see the data used for device-to-device secret backup and recovery processes. The encryption/decryption module 352 provides confidentiality to TEE 302, such that when data is provided by the user via trusted UI 310, the user-inputted data will be encrypted and stay encrypted inside the TEE 302. When data is exported out of the TEE 302, the data is decrypted by the encryption/decryption module 352. The encryption/decryption module 352 provides confidentiality to data transfers to/from the TEE 302, such that before data is transferred from electronic device 301 to another device (e.g., 102, 104, 106), the communicator 308 creates an encrypted channel between the two devices' TEEs, so that data transfer is confidential. That is, the encryption/decryption module 352 cooperates with data transferer 360 and communicator 308 to create an encrypted channel between the TEE 302 of electronic device 101 and another TEE (like TEE 302) of an external electronic device 102, 14, 106. Confidential data, including but not limited to the secrets and shares (e.g., 402 and 404 of FIG. 4), is encrypted outside of the TEE, such that the communicator 308 only handles and the encrypted channel only carries encrypted confidential data.

The error detector and corrector 354 protects data integrity when data is transferred between owner and trustees, and prevents trustees from modifying the data. In certain embodiments, the error detector and corrector 354 includes a checksum generator/verifier.

The context monitor 356 monitors the security of both execution environments 302 and 304 of the electronic device 301. For example, the context monitor 356 monitors network security, and performs attestation to ensure the TEE 302 is indeed secure. The error detector and corrector 354 provides transfer error detection and correction for the TEE 302. For example, when electronic device 301 sends data d and its checksum c=chksm(d) to a second electronic device 102, then the second electronic device 102 receives (d′, c′). The second electronic device 102 verifies chksm(d′)==c′. If so, second electronic device 102 sends an acknowledgement message (“ACK”) to the first electronic device 301; otherwise, second electronic device 102 sends an error message (“ERR”) to the first electronic device 301 and the two devices 301 and 102 try again. The second electronic device 102 may be able to correct several bit errors if error correction coding algorithms are used, e.g., Reed-Solomon codes. The checksums can be referred to as integrity information. Data d (for example, shares) is attached with checksum and a signature to ensure the data is not damaged or tampered by dishonest shareholders or hackers.

Additionally, the error detector and corrector 354 provides trustee tamper detection for the TEE 302. For example, for a secret, the share generator 344 of the electronic device 301 generates n shares{sⱼ}_{1≤j≤n} and n checksums {cⱼ=chksm(sⱼ)}_{1≤j≤n}, appends the n checksums to every share, and sends (sᵢ, {cⱼ}_{1≤j≤n}) to trustee i. A checksum function is a specific type of hash function. In certain embodiments, the share generator 344 generates n shares{sⱼ}_{1≤j≤n} by splitting the secret into the N parts {pⱼ}_{1≤j≤n}, computing N individual hashes {hⱼ=hash(pⱼ)}_{1≤j≤n} of respective ones of the N parts, and encrypting each of the N parts by appending a corresponding individual hash hᵢ to the respective individual part pᵢ. That is, the share generator 344 generates a share sᵢ=(pᵢ, hᵢ) by appending an individual hash hᵢ of a part to the part pᵢ itself. The hash of all shares {cⱼ}_{1≤j≤n} is different from the all of the individual hashes of the N parts {hⱼ}_{1≤j≤n}. If a small fraction of the n trustees is dishonest or hacked and send tampered sᵢ, cᵢ to the electronic device 301 (via the share generator 344) for recovery, then the electronic device 301 can leverage the n trustees' consensus of checksums to detect tampering and determine an identity of the dishonest trustee(s). The error detector and corrector 354 detects a hacked trustee device based on comparing a consensus of integrity information of the N shares to integrity information appended to a share retrieved from the hacked trustee device. For example, during a process for device-to-device secret recovery, the error detector and corrector 354 performs a “majority vote” for detection of “compromised” secret shares. That is, the error detector and corrector 354 compares to determine whether number of “trusted” trustee devices is greater than the number of “untrusted” devices. In response to determining a consensus (i.e., the number of “trusted” trustee devices is greater than the number of “untrusted” devices), error detector and corrector 354 determines that a process for device-to-device secret recovery will generate the correct hash through majority vote and then can correctly verify the integrity of the secret share, even if error detector and corrector 354 has not yet determined which trustee device has turned into an “untrusted” device and whether the hash is still correct.

The policy manager 358 manages different security policies, and enforces a selected security policy. The selected security policy can be user-selected and/or user-configured. As a non-limiting example, one security policy may restrict who can be a trustee, such as a rule that the trustees must be 2 friends and 2 family members. For example, the security policy may generically require that trustees have a “friend” or “family” relationship (e.g., as registered in an address book) to the owner of the electronic device 301. The policy manager 358 enables the user to define the level of trust for the trustees, for example, the having the “family” relationship to the user/owner may have a higher level of trust than a “friend,” and the user may define a security policy that requires such requires at least one trustee device to be from among family member devices for backup and recovery processes. Alternatively, the security policy may require that trustees be a specific person or specified people (e.g., Nancy and Jamie). Another security policy may allow different secrets (including corresponding shares generated therefrom) to have different policies. Another security policy may forbid or require that different secrets (including corresponding shares generated therefrom) have the same security policies.

The data transferer 360 includes a share distributor 362 and a share collector 364. The share distributor 362 distributes shares (for example, shares 404a-404e of FIG. 4) of a secret to trustees' devices. When transferring a share to a trustee's device, the share distributor 362 ensures the correct share is sent, by not sending another secret's share. That is, the share distributor 362 may assign each share to a specific trustee's device. For example, the share distributor 362 may assign (for example, sequentially) share 404a-404e to respective trustee devices 406a-406e, as shown in FIG. 4. The share distributor 362 keeps track of how many shares have been sent to trustees' devices. The share distributor 362 triggers a warning alert if generated shares are not all distributed before a timeout, such as a backup time limit.

The share collector 364 collects shares from trustees' devices for secret recovery. The share collector 364 ensures the received share is a specified share that was requested, not someone else's share and not another secret's share. The share collector 364 keeps track of how many shares have been received. The share collector 364 triggers a warning alert if not enough shares are collected before a timeout, such as a recovery time limit.

FIG. 4 illustrates an example block diagram 400 of setting a secret, generating shares of the secret, and transferring the shares from a source device to a plurality of trustee devices in accordance with an embodiment of this disclosure.

User-adjustable configuration settings specify that n=5 and k=3, which enables a source device, such as electronic device 301 to backup any secret 402 to five (5) trustee devices 406a-406e (generally, 406) and requires retrieval of shares from three (3) trustee devices 406 to recover the secret 402. The source device (301) initiates the TEE 302 to receive and setup a secret 402 for D2D secret backup. The trustee devices 406a-406e can be the same as or similar to the external electronic devices 102 and 104 of FIG. 1. The secret 402 (for example “MyPaSsWoRd”) can be a string of 10 characters.

As introduced above, the share generator 344, in response to receiving the secret 402, generates five (5) shares 404 by applying an algorithm selected by the algorithm selector 342. By applying the selected algorithm, the share generator 344 splits the secret 402 into 5 parts, which may or may not be mutually exclusive parts, and encrypts each of the 5 parts. The 5 encrypted parts of the secret are together referred to as shares 404, and individually referred to as shares 404a-404e.

The source device (301) can access any two trustee devices 406; but cannot recover the secret 402 from fewer than three (<k where k=3) of the trustee devices 406. That is, if at most 2 trustee devices 406 are not available for any reason, then the source device (301) can still recover the secret 402.

The source device (301) relies on short-range D2D communication provided by the local connection driver 382, so TEE 302 is able to perform device-to-device secret backup and recovery processes according to this disclosure without need for a network (such as network 162).

FIG. 5 illustrates an example block diagram 500 of recovering a secret from a number of shares that are transferred from a number of trustee devices to a recovery device in accordance with an embodiment of this disclosure.

As introduced above, at the time of recovery, a recovery device, such as electronic device 301, requires at least 3 trustee devices (k=3) to recover the secret 402. The recovery device (301) initiates the TEE 302 to recover a secret 402 using D2D secret recovery processes. The first trustee device 406a, third trustee device 406c, and fifth trustee device 406e transfer respective shares 404a, 404c, and 404e to the recovery device (301) via short-range D2D communication provided by the local connection driver 382.

As introduced above, the secret recovery module 346, in response to retrieving at least three shares 404a, 404c, and 404e (together referred to as retrieved shares 504), reconstructs the secret 402 by applying the algorithm selected by the algorithm selector 342. By applying the selected algorithm, the secret recovery module 346 decrypts the 3 shares 504 into raw/non-encrypted parts of the secret 402, and combines the 3 raw/non-encrypted parts into a reconstructed secret 402.

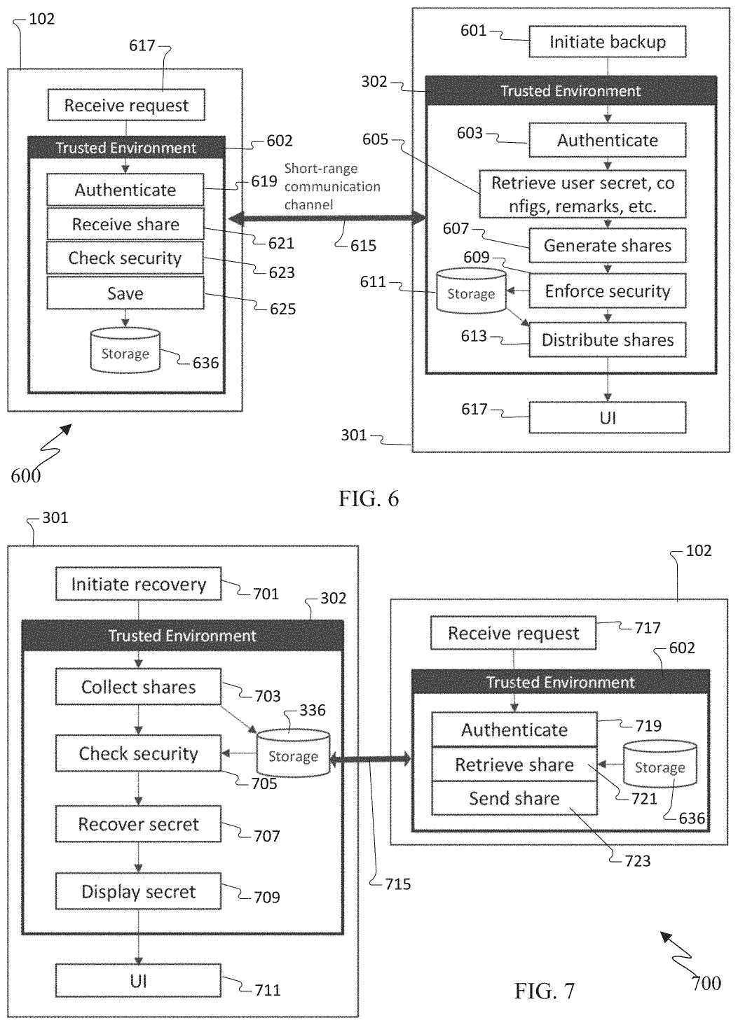

FIG. 6 illustrates an example block diagram of a main electronic device 301 and a trustee electronic device 102 performing device-to-device secret backup process 600 in accordance with an embodiment of this disclosure. The main electronic device 301 includes the TEE 302, as described above. The trustee electronic device 102 includes a TEE 602, which can operate in a same or similar way as the TEE 302 and can include the same or similar components as TEE 302.

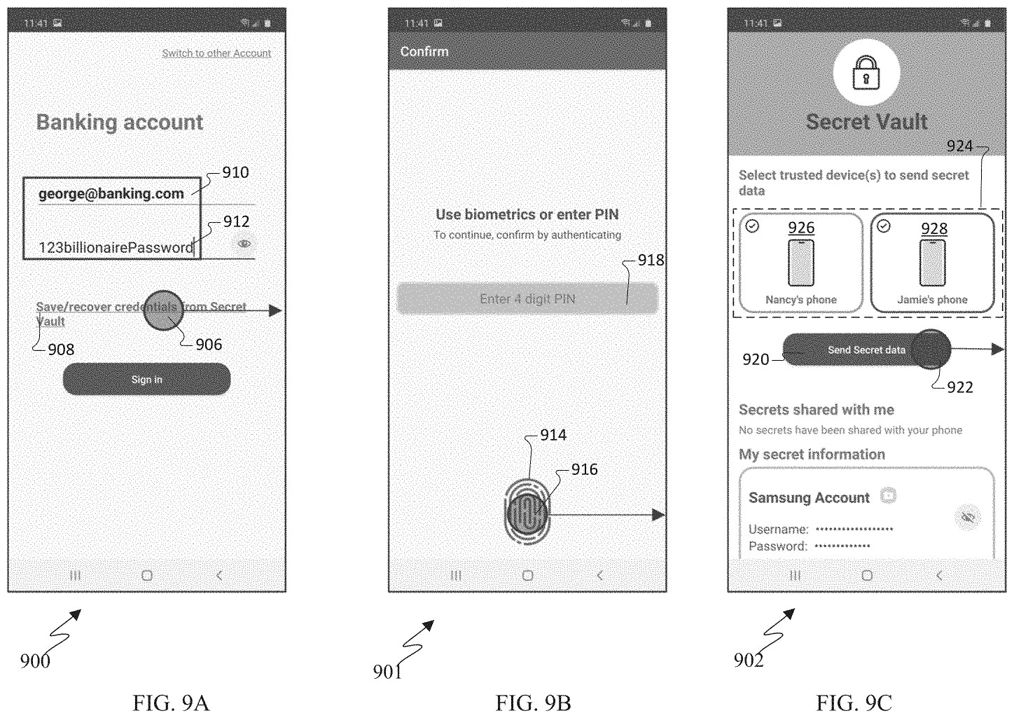

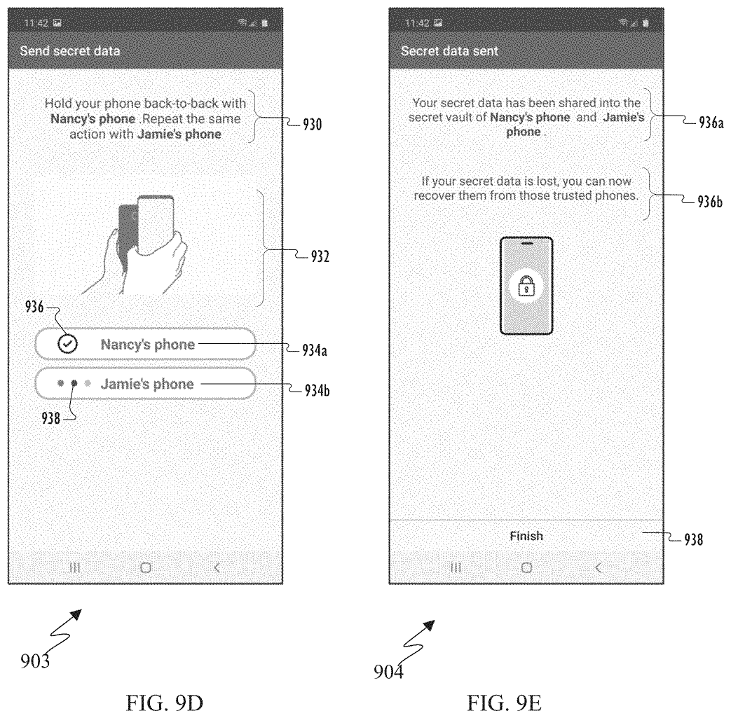

The process 600 begins at block 601, at which the processor 240 initiates a D2D secret backup process. For example, user may select to open a trusted app 263 by touching an associated icon or associated button provided by a trusted UI. In certain embodiments, initiation of the D2D secret backup process is in response to receiving user input that opens the secret vault app 263, which user input can be received through the user interface 306 of the non-secure execution environment 304 or can be received through the trusted UI 310. As a particular example, the user may select a secret vault button (908 of FIG. 9A) that triggers the processor to open the secret vault app 263.

In response to detecting that the D2D secret backup has been initiated, the user interface (UI 306 or trusted UI 310) triggers the TEE 302 to authenticate (at block 603) the identity of the user using authenticator 320.

At block 605, the TEE 302 retrieves confidential data using the trusted UI 310. More particularly, the confidential data includes user secret, user-adjustable configuration settings, remarks, etc. Examples of the retrieved confidential data includes the settings 802, 804a-804b shown in FIGS. 8A-8B. In some embodiments, the TEE 302 stores at least some of the retrieved confidential data, such as configuration settings, in the storage 336.

At block 607, in response to receiving a user secret, the TEE 302 generates N shares using share generator 344. At block 609, the TEE 302 enforces a security policy using policy manager 358. At block 611, the TEE 302 stores the N generated shares in the (database) storage 336.

At block 613, the TEE 302 distributes the n generated shares to n trustee devices using share distributor 362. In some embodiments, the TEE 302 iteratively distributes each of the n generated shares to a different trustee device from among n trustee devices. In at least one embodiment, distributing the N shares includes receiving a generated share from the storage 336, establishing an encrypted channel 615 between the two devices' TEEs 302 and 602, and transferring the share from the TEE 302 of the main electronic device 301 to the TEE 602 of the trustee electronic device 102 using short-range communication. At block 617, the TEE 302 outputs one or more user interfaces that support the process 600 using the UI 306 of the non-secure environment 304.

As described above, blocks 601-617 of the process 600 are implemented within the TEE 302. Additionally, the device-to-device secret backup process 600 begins in the trustee electronic device 102 at block 617, at which a request is received from the main electronic device 301, requesting to backup a secret. In response to detecting that the request to backup a secret has been received, the TEE 602 performs a user authentication process (at block 619) using its authenticator (320). At block 621, the TEE 602 receives a share from the TEE 302 of the main electronic device 301 using short-range communication of the encrypted channel 615 between the two devices' TEEs 302 and 602. At block 623, the TEE 602 checks the security of the received share using security enforcer 350. In at least one embodiment, checking the security of the received share includes further encrypting the share using the encryption/decryption module (352) of the TEE 602. At block 625, the TEE 602 stores the received share in a database storage 636 of the TEE 602.

FIG. 7 illustrates an example block diagram of a main electronic device 301 and a trustee electronic device 102 (i.e., the same as shown in FIG. 6) performing device-to-device secret recovery process 700 in accordance with an embodiment of this disclosure.

The process 700 begins at block 701, at which the processor 240 initiates a D2D secret recovery. For example, user may select to open a trusted app 263 by touching an associated icon or associated button provided by a user interface.

In response to detecting that the D2D secret recovery has been initiated, the TEE 302 collects (at block 703) k shares trustee electronic devices using secret recovery module 346. In at least one embodiment, collecting the k shares includes establishing an encrypted channel 715 between the two devices' TEEs 302 and 602, iteratively retrieving a share from the TEE 602 of k trustees' electronic devices (including 102) using short-range communication, and storing the retrieved share in storage 336 of the main electronic device 102.

At block 705, the TEE 302 checks the security of the received share using security enforcer 350. At block 707, the TEE 302 reconstructs the secret by decrypting the k received shares using the encryption/decryption module 352, and combining the decrypted parts of the secret using the secret recovery module 346. At block 709, the TEE 302 outputs the reconstructed secret (for example, by displaying the secret) using trusted UI 310. At block 711, the TEE 302 outputs one or more user interfaces that support the process 700 using the UI 306 of the non-secure environment 304.

As described above, blocks 701-711 of the process 700 are implemented within the TEE 302. Additionally, the device-to-device secret recovery process 700 begins in the trustee electronic device 102 at block 717, at which a request is received from the main electronic device 301, requesting to recover a secret. In response to detecting that the request to recover a secret has been received, the TEE 602 performs a user authentication process (at block 719) using its authenticator (320). In certain embodiments, the user authentication process (at block 719) includes both the owner of main electronic device 301 and the trustee (e.g., owner of the trustee electronic device 102) performing biometric authentication at the same time on each of the trustee devices to prevent the case of betrayed trustee.

At block 721, the TEE 602 retrieves a share from the storage 636 of the trustee electronic device 101. At block 723, the TEE 602 sends the retrieved share to the TEE 302 of the main electronic device 301 using short-range communication of the encrypted channel 715 between the two devices' TEEs 302 and 602.

FIGS. 8A-12D illustrate various user interfaces for D2D secret backup and recovery processes according to this disclosure. It is understood that the user interfaces shown in FIGS. 8A-12D are provided by any suitable electronic device (e.g., 101, 200, 301) that supports D2D secret backup and recovery. For simplicity, the user interfaces shown in FIGS. 8A-12D will be described as being provided by the electronic device 301 of FIG. 3A in the role of a main electronic device that interacts with a user that is the owner of the main electronic device. The main electronic device can perform the functions of a source device (introduced with FIG. 4 and FIG. 6) or a recovery device (introduced with FIG. 5 and FIG. 7). Particularly, the main electronic device can communicate with multiple trustee devices, which for simplicity, will be described as being provided by the external electronic devices 102 and 104 of FIG. 1. The TEE 302 of the main electronic device generates and outputs the user interfaces shown in FIGS. 8A-12D through the trusted UI 310.

FIGS. 8A and 8B illustrate example user interfaces 800 and 801 for setting a secret and generating shares of the secret in accordance with an embodiment of this disclosure. As shown in FIG. 8A, the user interface 800 enables the trusted input 312 to receive user input including confidential data, such as a secret 802, user-adjustable configuration settings 804a specifying a value for n 806 and a value for k 808. The user interface 800 enables the trusted input 312 to receive configuration settings 804a specifying: (i) a user-selection to allow or disallow use of multi-level secret sharing 810; and (ii) a selectable-algorithm 812 that is used to generate N 806 shares from the secret 802. The selectable-algorithm 812 is also used to reconstruct the secret 802 from K shares. The user interface 800 includes a generate secret shares button 814 that, when selected (e.g., touched or clicked) by the user, causes the TEE 302 to generate n shares.

As shown in FIG. 8B, the user interface 801 enables the trusted output 314 to show the confidential data, which was received via user interface 800, to the owner/user. In the example shown FIG. 8B, the secret 802 is aStrongPassw0rd; the value of n 806 is three (3); and the value of k 808 is two (2). The user interface 801 displays additional user-adjustable configuration settings 804b for each of the n=3 shares, which enable the trusted input 312 to receive a user-selected trustee device 816a, 816b, and 816c (or trustee) and a user-selection 818a, 818b, and 818c to allow or disallow the trustee to view the secret. In certain embodiments, the although the selected-algorithm 812 prevents a trustee from seeing the secret, configuration settings can be modified by user-selections 818a-818c of the owner of the source electronic device such that encryption of the plurality of secret shares allow only selected trustee devices (which could mean none of the trustee devices are selected) can access the secret by decrypting the secret share transferred to the trustee device. Together, each of the trustee devices identified by the of the user-selected trustee devices 816a, 816b, and 816c form a trustee grouping. The TEE 302 stores identifiers of each of the user-selected trustee devices 816a, 816b, and 816c in relationship to respective ones of the N shares. Specifically, Share 1 is related to the identifier (e.g., “ED-ID1”) of the first user-selected trustee device 816a, Share 2 is related to the identifier (e.g., “ED-ID2”) of the second user-selected trustee device 816b, and Share 3 (e.g., “ED-ID3”) is related to the identifier of the third user-selected trustee device 816c. For example, if the identifiers ED-ID1, ED-ID2, and ED-ID3 respectively identify the second and third electronic devices 102 and 104, and a fourth electronic device (not shown), then the TEE 302 follows the user-selected configuration settings 804b by specifically assigning Share 1, Share 2, and Share 3 to be transferred to the identified second, third, and fourth electronic devices, respectively.

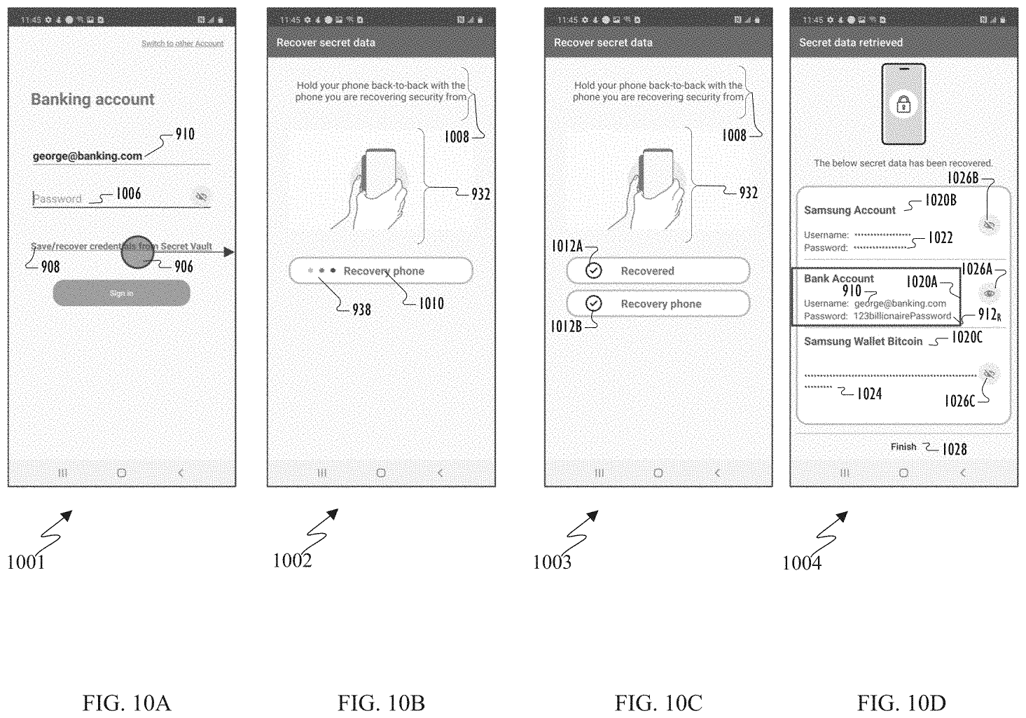

According to the scenarios provided in this disclosure, the first, second, and third electronic devices 101, 102, and 104 are owned by users named George, Nancy, and Jamie, respectively. In an example 1-to-2 scenario in which a secret backup to a trustee grouping of multiple (i.e., 2) trustee electronic devices occurs, the configuration settings for a first share may specify Nancy's smartphone as the user-selected trustee device 816a. The configuration settings for a second share may specify Jamie's smartphone as the user-selected trustee device 816b. Additional details of this 1-to-2 scenario, are described more particularly below with reference to FIGS. 9A-9E and FIGS. 10A-10D.

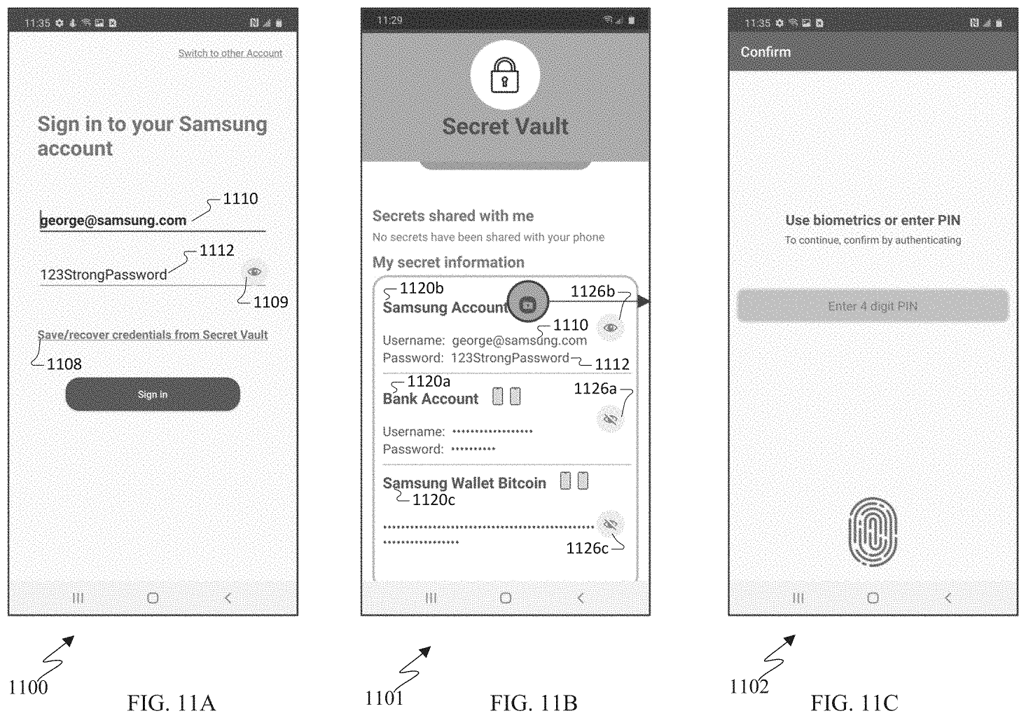

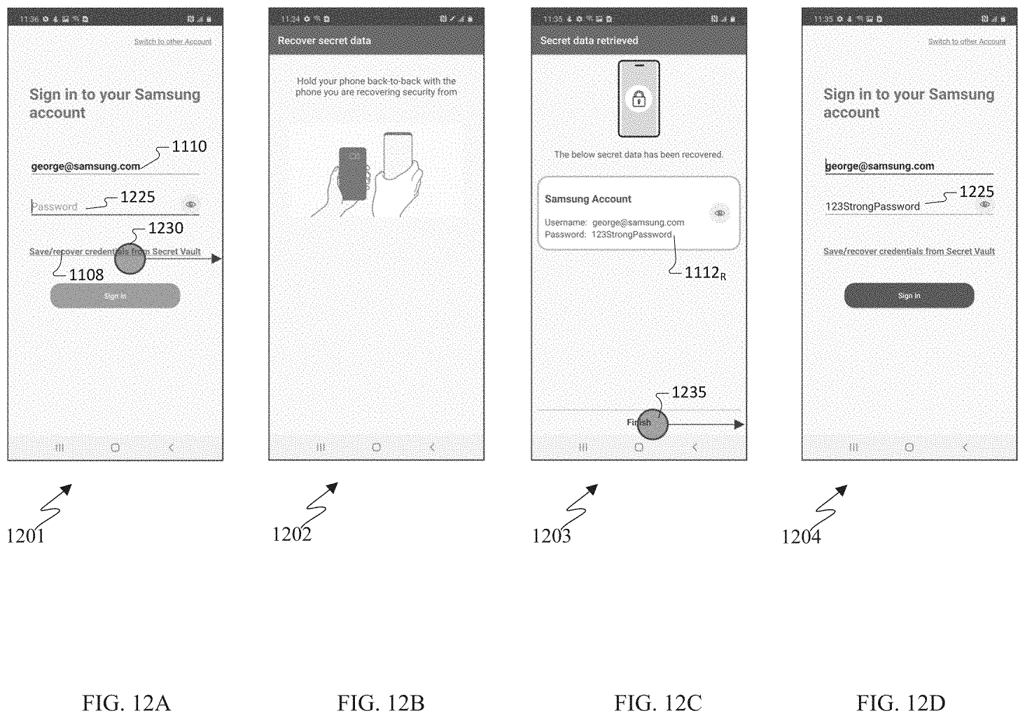

In another example 1-to-1 scenario in which a secret backup to a trustee grouping of one external electronic device that is owned by the same owner of the electronic device 301 occurs, the configuration settings for the sole, first share may specify an old smartphone as the user-selected trustee device 816a. Additional details of this 1-to-1 scenario, are described more particularly below with reference to FIGS. 11A-11C and FIGS. 12A-12D.

FIGS. 9A-9E illustrate example user interfaces 900-904 for device-to-device secret backup to multiple trustee electronic devices in accordance with an embodiment of this disclosure. More particularly, FIGS. 9A-9E relate to the 1-to-2 scenario in which a secret backup to a trustee grouping of multiple (i.e., 2) trustee electronic devices occurs. As shown in FIG. 9A, the user interface 900 is provided by a payment trusted app (264) that prompts the user to provide banking account login credentials (e.g., username and password). The secret vault app (263), in cooperation with the payment trusted app (264), displays a secret vault button 908 (illustrated as “Save/recover credentials from Secret Vault”) using trusted display 314. In response to receiving user input 906 on the secret vault button 908, TEE 302 initiates the D2D secret backup process, and changes the screen, for example, to display the user interface 901 of FIG. 9B. In some embodiments, the user interface 900 enables the trusted input 312 to receive user input including some non-confidential information such as a username 910 and some confidential data, such as a secret 912 (e.g., password).

In FIG. 9B, the user interface 901 prompts the user to provide user input for authenticating the user's identity. The user interface 901 includes a fingerprint scanner 914, which receives the fingerprint input 916 from the user. For example, the finger of George, the owner of secret 912, is placed on the fingerprint scanner 914 for biometric authentication. For owners who do not provide biometric data, the user interface 901 includes a PIN field 918 the receives a PIN input from the user. In response to determining that user authentication data validates the user for authorized to access the TEE 302, TEE 302 changes the screen, for example, to display the user interface 902 of FIG. 9C.

In FIG. 9C, the user interface 902 displays a prompt (“Select trusted device(s) to send secret data”) prompting the user to select one trustee device that will receive a share of the secret 912. The user interface 902 displays a send button 920 that, when pressed-upon by a user touch 922, causes the TEE 302 to send a share of the secret 912 to a recipient selected from the trustee grouping 924 that corresponds to the configuration settings for the secret 912. The user interface 902 displays the trustee grouping 924, which includes two trustee devices, namely, Nancy's smartphone and Jamie's smartphone, each of which has been securely paired to the first electronic device 101 (i.e., source device). The user interface 902 displays two trustee device buttons 926 and 928 that enable the user to select either Nancy's smartphone or Jamie's smartphone (but not both) as the recipient. In certain embodiments, the user may choose a recipient by providing input on one of the trustee device buttons 926 and 928 and then press the send button 920. In response to receiving user input selecting one trustee device button 926 or 928, the TEE 302 changes the screen, for example, to display the user interface 903 of FIG. 9D.

In FIG. 9D, the user interface 903 displays an instructional message 930 telling the user “Hold your phone back-to-back with Nancy's phone. Repeat the same action with Jamie's phone.” The user interface 903 displays a demonstrative animation 932 showing the user how to hold the owner's electronic device 101 back-to-back with a trustee's electronic device 102 or 104.

When the electronic device 101 and the second electronic device 102 (Nancy's phone) are moved into locations in close proximity to each other, the TEE 302 detects the presence of the second electronic device 102 by using the local connection driver 382, and in response to detection, transfers a share 404 to the trusted database storage 636 of the second electronic device 102. When the electronic device 101 and the third electronic device 104 (Jamie's phone) are moved into locations in close proximity to each other, the TEE 302 repeats this process in analogous manner. As a particular example, the TEE 302 uses the data transferer 360 to transfer the first share 404a to the second electronic device 102 and to transfer the second share 404b to the third electronic device 104. In response to completing transmission of N shares to K trustee devices, the TEE 302 changes the screen, for example, to display the user interface 904 of FIG. 9E.

The user interface 903 displays the names 934a-934b of the devices belonging to the trustee grouping 924. Next to each of the names, the user interface 903 displays a status indicator 936 or 938 indicating a confirmation (936) that a share 404 has been transferred to the named trustee device or indicating an in-progress status (938) that the electronic device 101 in has initiated but not completed a process of transferring a share 404 to the named trustee device.

In FIG. 9E, the user interface 904 displays a first confirmation message 936a telling the user “Your secret data has been shared into the secret vault of Nancy's phone and Jamie's phone.” Additionally, the user interface 904 displays a second confirmation message 936b telling the user “If your secret data is lost, you can now recover them from those trusted phones.” The user interface 904 displays a finish button 938, which when touched by the user, triggers the TEE 302 to exit the secret vault app 263 and change the screen, for example, to display the user interface 1000 of FIG. 10A.

FIGS. 10A-10D illustrate example user interfaces 1001-1004 for device-to-device secret recovery from multiple trustee electronic devices in accordance with an embodiment of this disclosure. While the recovery process in FIGS. 10A-10D will be described in a scenario in which the electronic device 101 that retrieves shares and reconstructs a secret from the retrieved shares, it is understood that a different electronic device (other than the original electronic device that generated the shares) can retrieve shares and reconstruct the secret from the retrieved shares.

More particularly, FIGS. 10A-10D relate to the 1-to-2 scenario in which a secret recovery from the trustee grouping 924 of multiple (i.e., 2) trustee electronic devices occurs. As shown in FIG. 10A, the user interface 1001 is provided by the payment trusted app (264) that prompts the user to provide banking account login credentials (e.g., username and password). FIG. 10A, in comparison to FIG. 9A, shows that the password field 1006 is blank because the user has not yet input confidential data, such as the secret 912. The secret vault app 263, in cooperation with the payment trusted app (264), displays the secret vault button 908 using trusted display 314. In response to receiving user input 906 on the secret vault button 908 via the trust input 312, TEE 302 determines whether the trusted database storage 336 stores confidential data in relationship to the username 910 (“george@banking.com”) inputted by the user. If the TEE 302 determines the trusted database storage 336 does not store any confidential data in relationship to the username 910, then TEE 302 initiates the D2D secret backup process, and changes the screen to display the user interface 901 of FIG. 9B. Alternatively, in response to identifying the trusted database storage 336 does store the secret 912 in relationship to the username 910, the TEE 302 initiates the D2D secret recovery process, and changes the screen, for example, to display the user interface 1002 of FIG. 10B.

In FIG. 10B, the user interface 1002 displays an instructional message 1008 telling the user “Hold your phone back-to-back with the phone you are recovering security from,” and the demonstrative animation 932. Next to a generic name 1010 (“Recovery phone”) of a trustee device, the user interface 1002 displays one of the status indicators 936 or 938.

When the electronic device 101 is moved into a location in close proximity to either one of the trustee devices belonging to the trustee grouping 924 (specifically, the second electronic device 102 (Nancy's phone) or the third electronic device 104 (Jamie's phone)), the TEE 302 detects the presence of the trustee device 102 or 104 by using the local connection driver 382. In response to the detection, the TEE 302 identifies the trustee device and retrieves the share 404 corresponding to the username 910 from the trusted database storage 636 of the second electronic device 102. For example, the TEE 302, in response to identifying the second electronic device 102 (Nancy's phone) in close proximity, retrieves the share 404a. Alternatively, in response to identifying the second electronic device 104 (Jamie's phone) in close proximity, the TEE 302 retrieves the share 404b. Upon completing retrieval of one share 404 from a trustee device, the TEE 302 changes the screen to display the user interface 1003 of FIG. 10C, which includes a first confirmation status indicator 1012a indicating one of the shares 404a-404b has been retrieved. The user interface 1003 continues display of the instructional message 1008, and the user repeats this share retrieval process with the other trustee device. In response to completing retrieval of N shares from K trustee devices (i.e., completing retrieval of the other share 404 from the other trustee device), the user interface 1003 displays a second confirmation status indicator 1012b indicating the other one of the shares 404a-404b has been retrieved, and the TEE 302 changes the screen, for example, to display the user interface 1004 of FIG. 10D.

In FIG. 10D, the user interface 1004 displays the recovered secret 912_{R}, which the TEE 302 reconstructed from the shares 404a-404b retrieved from the second and third electronic devices 102 and 104 (namely, Nancy's phone and Jamie's phone). Also from information stored in the trusted database storage 336, the user interface 1004 also displays information related to the secret 912, such as the username 910 paired with the secret 912 as user credentials for gaining access to the bank account 1020a.

As another example of information related to the secret 912, the user interface 1004 displays the name of the bank account 1020a to which the secret 912 provides access. The bank account 1020a is one among a list of other accounts for which the owner/user has used the secret vault app to backup other secrets 1022 and 1024. For example, the list of other accounts includes a SAMSUNG account 1020b and a SAMSUNG wallet Bitcoin account 1020c.

In the example screenshot of the user interface 1004 that is shown in FIG. 10D, the user has previously touched the reveal/hide button 1026a, which reveals the raw, non-encrypted versions of the recovered secret 912_{R} (“123billionairePassword”) as well as the information (910 and 1020a) related to the secret 912. The eye-ball image on the reveal/hide button 1026a indicates that the raw, non-encrypted versions are being displayed for the bank account 1020a. In some embodiments, the slashed eye-ball image on the other reveal/hide buttons 1026b-1026c indicates that the owner/user has not yet pressed the button in order to change from hidden to revealed. In some embodiments, the slashed eye-ball image indicates that the owner/user has not performed a recovery process to reconstruct the other secrets 1022 and 1024 from the respective trustee groupings (similar to 924) that correspond to the configuration settings for the other secrets 1022 and 1024.

The user interface 1004 displays a finish button 1028, which when touched by the user, triggers the TEE 302 to exit the secret vault app 263 and change the screen, for example, to display the user interface 900 of FIG. 9A. More particularly, in response to detecting user input on the finish button 1028, the TEE 302 populates the recovered secret 912₈ into the password field 1006, thereby enabling the user to sign-in to the bank account via the payment trusted app (264).

FIGS. 11A-11C illustrate example user interfaces 1100-1102 for device-to-device secret backup to a second electronic device having a same owner as the main electronic device in accordance with an embodiment of this disclosure. More particularly, FIGS. 11A-11C relate to the 1-to-1 scenario in which a secret backup to a trustee grouping of one external electronic device 102 that is owned by the same owner of the electronic device 301 occurs.

As shown in FIG. 11A, the user interface 1100 is provided by an app 262 that prompts the user to provide account login credentials (e.g., username and password). The user interface 1100, in comparison to the user interface 900 of FIG. 9A, includes similar elements. Particularly, the fields for the username 1110 (“george@samsung.com”) and the password secret 1112 (“123StrongPassword”), and a secret vault button 1108 of FIG. 11A perform the same or similar features as corresponding elements 910, 912, and 908 of FIG. 9A. The password secret 1112 is the same as the other secret 1022 of FIG. 10D. The user interface 1100 includes a reveal/hide button 1109 that corresponds to the password secret 1112 and that performs a similar function as the reveal/hide buttons 1026a-1026c of FIG. 10D. Descriptions of these features will not be duplicated here.

As shown in FIG. 11B, the user interface 1101, in comparison to the user interface 1004 of FIG. 10D, includes similar elements. Particularly, the password secret 1112, the list of accounts 1120a-1120c, reveal/hide button 1126a-1126c, and the other secrets 912 and 1024 shown in FIG. 11B perform the same or similar features as corresponding elements 1022, 920a-920c, 926a-926c, 912R, 1014 of FIG. 10D. Descriptions of these features will not be duplicated here. The user interface 1101 shows that the username 1110 paired with the password secret 1112 will be backed up. The user input 1130 on a backup button (illustrated as a folder with a keyhole) triggers the TEE 302 to enforce security using policy manager 358. Enforcing security can include changing the screen to display the user interface 1102 of FIG. 11C, which is the same as the user interface 901 of FIG. 9B.

FIGS. 12A-12D illustrate example user interfaces 1201-1204 for device-to-device secret recovery from a second electronic device 102 (e.g., the owner's old phone) having a same owner as the main electronic device in accordance with an embodiment of this disclosure. More particularly, FIGS. 12A-12D relate to the 1-to-1 scenario in which a secret recovery from the trustee grouping of one external electronic device 102 that is owned by the same owner of the electronic device 301 occurs. The user interface 1201 shown in FIG. 12A is similar to and performs a similar function as the user interface 1001 of FIG. 10A. That is, the user interface 1201 enables the owner/user to input the username 1110 for the account 1120b and to apply user input 1230 on the vault button 1108. The user interface 1202 shown in FIG. 12B is similar to the and performs a similar function as the user interface 1002 of FIG. 10B. That is, the user interface 1202 enables the TEE 302 to retrieve a share (e.g., 404c) from the second electronic device 102.

The user interface 1203 shown in FIG. 12C is similar to the and performs a similar function as the user interface 1004 of FIG. 10D. That is, the user interface 1203 enables the owner/user to see the recovered secret 1112_{R}, which the TEE 302 reconstructed from the share (404c) retrieved from the second electronic device 102 (namely, owner's old phone). The user interface 1203 displays a finish button 1235, which when touched by the user, triggers the TEE 302 to exit the secret vault app 263 and change the screen, for example, to display the user interface 1204 of FIG. 12D. More particularly, in response to detecting user input on the finish button 1235, the TEE 302 populates the recovered secret 1112_{R} into the password field 1215, thereby enabling the user to sign-in to the SAMSUNG account via the app 262.

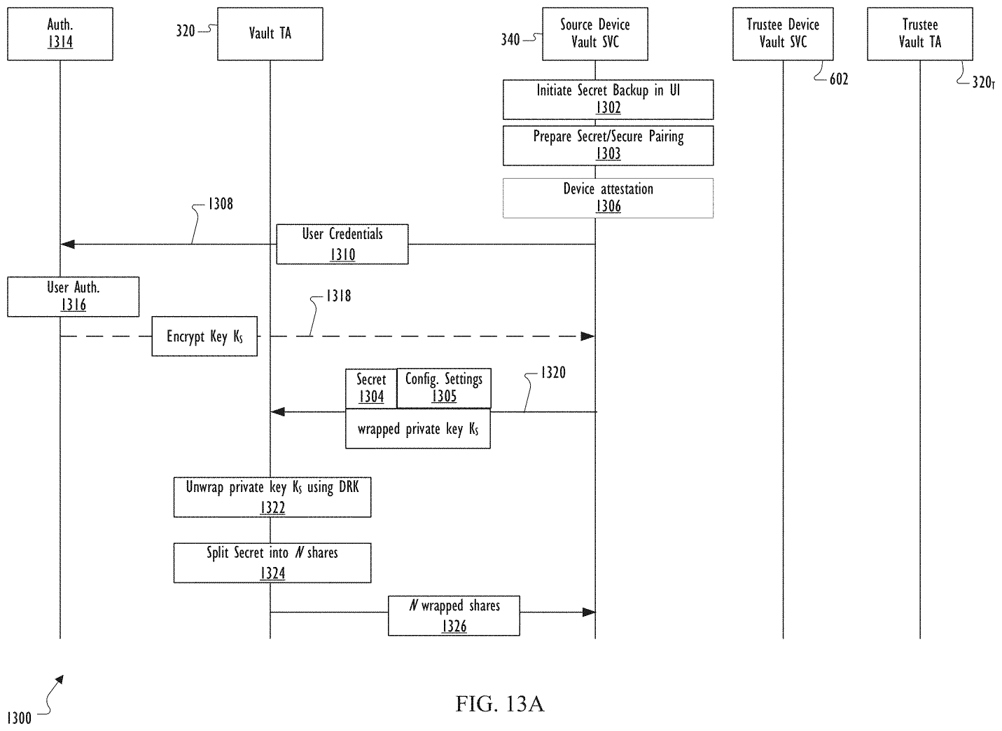

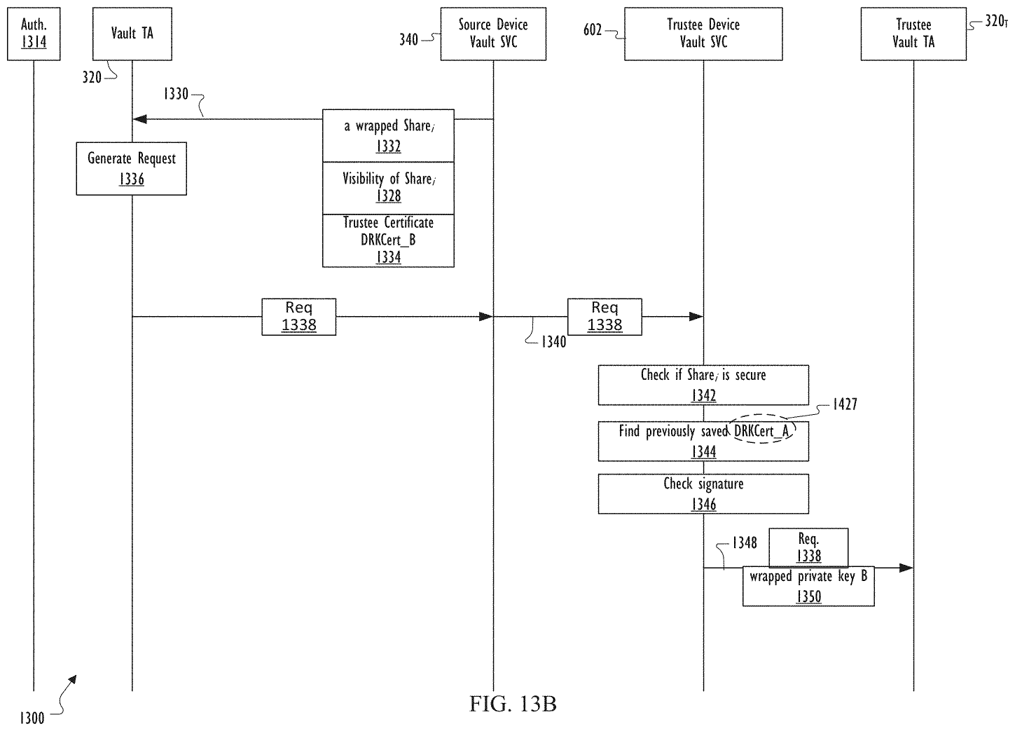

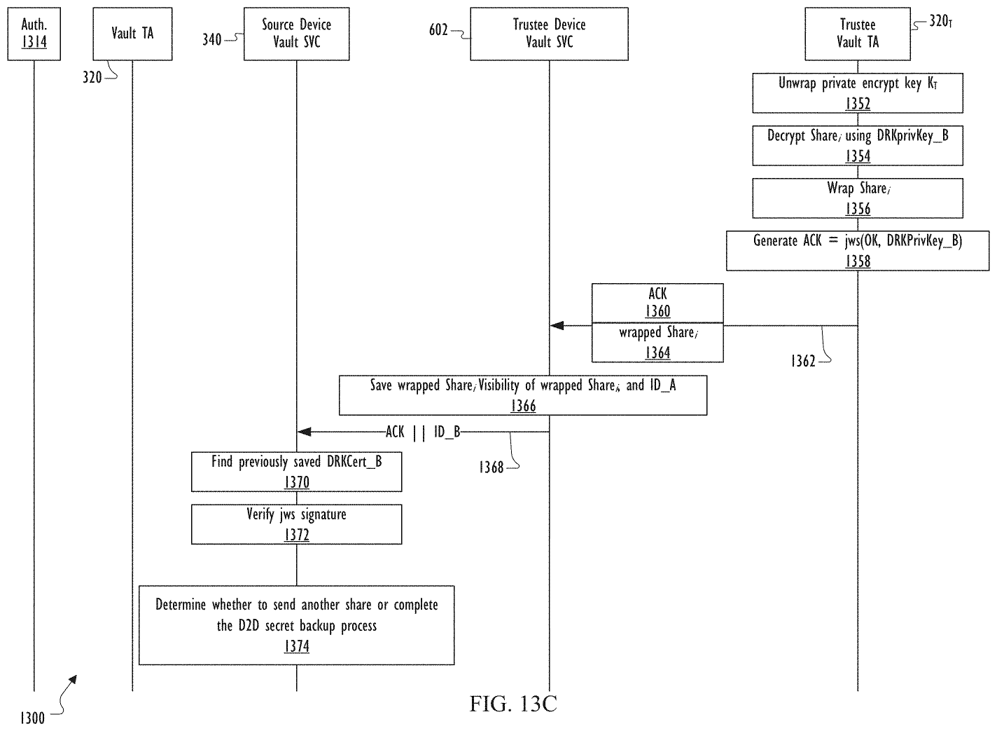

For ease of explanation, FIGS. 13, 14, and 15 will be described as though the first electronic device 101 is a source electronic device that generates a secret, the second electronic device 102 gets set as a trustee electronic device for receiving and storing a share of the secret, and the first electronic device 101 is a recovery electronic device that retrieves the share of the secret from the trustee electronic devices. As illustrated in FIGS. 13, 14, and 15, the source/recovery electronic device is simply identified to as “A,” and the trustee electronic device is simply referred to as “B.”

FIG. 13 (including FIGS. 13A-13C) illustrates a process 1300 for device-to-device secret backup in accordance with an embodiment of this disclosure. At block 1302, the source electronic device 101 initiates a trusted D2D secret backup process 1300.

It is understood that the processor 340 of the TEE 302 of the source electronic device 101 performs the trusted D2D secret backup process 1300 in collaboration with the TEE 602 of a trustee electronic device 102. For ease of visual aid, the trusted processor 340 of the source electronic device 101 is shown as the “Source Device Vault Service (SCV),” and the trusted authenticator 320 of the source electronic device 101 is shown as the “Vault TA.” Also for ease of visual aid, “Trustee Device Vault SVC” and “Trustee Vault TA” respectively refer to the TEE 602 and authenticator 320_{T} (with a subscript T indicating a relationship to the trustee device) of the trustee device 102. The processes performed at block 1302 and at block 601 of FIG. 6 are similar, and a duplicative description is not provided here.

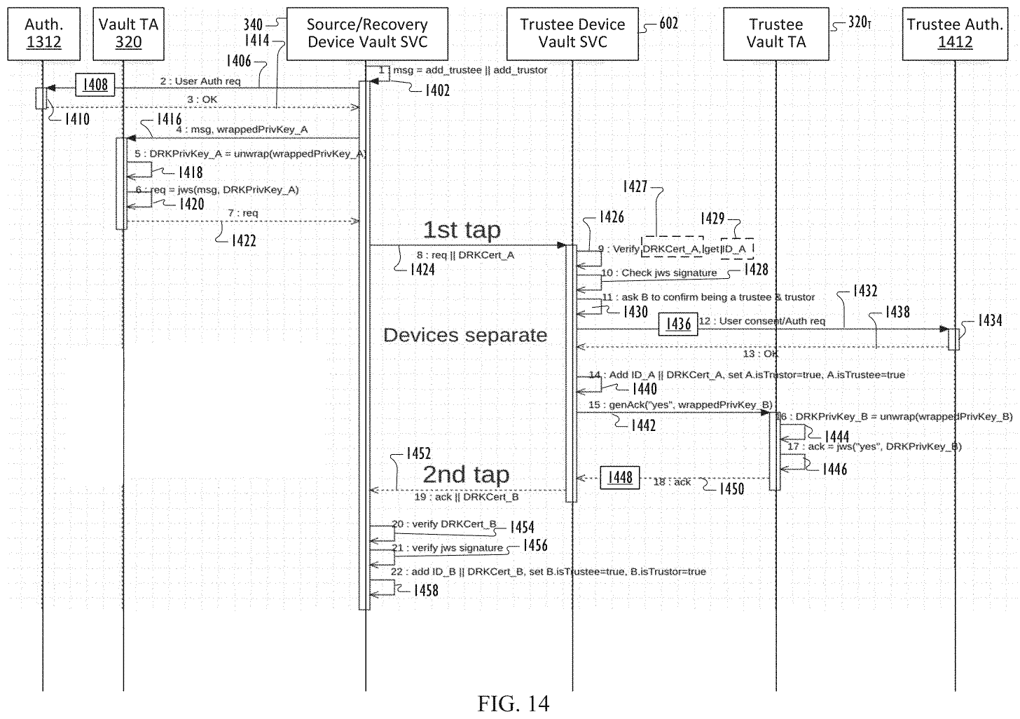

At block 1303, the processor 340 prepares a secret 1304, which preparation includes performing the process 1400 (FIG. 14) for pairing a source electronic device 101 to a trustee electronic device (for example, second electronic device 102, or third electronic device 104). For clarity, refer to the description of FIG. 14 as the description of block 1303, and a duplicative description is not provided here. Examples of the secret include the secret 802 of FIG. 8A, bank account password secret 910 of FIG. 9A, the passphrase secret 1024 of FIG. 10D, or SAMSUNG account password secret 1112 of FIG. 11A. If the source electronic device 101, as trustor, has previously paired with and added the second electronic device 102 as a trustee device, then there is no need for the source electronic device 101 to request the second electronic device 102 to authenticate.

In certain embodiments, preparation (at block 1303) of a secret includes receiving confidential data, as described above with reference to block 605 of FIG. 6, and duplicative descriptions are avoided here. Examples of the confidential data include the secret 1304 and user-adjustable configuration settings 1305. The secret 1304, for example, the processor 340 may read in the secret from a memory device or may receive the secret through a user interface.

At block 1306, the processor 340 performs device attestation of the source electronic device 101. In certain embodiments, in performance of device attestation, the user interface (UI 306 or trusted UI 310) sends a user authentication request 1308, which includes user credentials 1310, to the authenticator 320. Alternatively, in certain embodiments, the user interface transmits the user authentication request 1308 to an authentication service provided by the server 106. For simplicity, FIG. 13 shows a generic authenticator 1314 can represent the authenticator 320 or the authentication service provided by the server 106, but the process 1300 will be described in terms of the authenticator 320 performing (at block 1316) user authentication processes.

At block 1316, the authenticator 320 determines whether the received user credentials 1310 were received from the owner of the source electronic device 101 by comparing the user credentials 1310 to a credential C previously registered into the TEE 302 by the owner. Examples of the credential C include a biometric template or a secret question/answer pair. In certain embodiments, the user authentication processes included generating (e.g., deriving) private source encrypt key K_{S} from the credential C, for example, using the encrypter/decrypter 352. That is, in certain embodiments, the private source encrypt key K_{S} is derived from the biometric information. The authenticator 320 stores the source encrypt key K_{S} in secure storage 336 of the source electronic device 101. The processes performed at block 1316 and at block 603 of FIG. 6 are similar, and a duplicative description is not provided here. Based on the results of the user authentication, the authenticator 320 sends an acknowledgement 1318, which includes the private source encrypt key K_{S}, to the processor 340. In this non-limiting example, the private source encrypt key K_{S}, is also referred to as “PrivKey_A.”

At operation 1320, in response to receiving the acknowledgement 1318, the processor 340 wraps the source encrypt key K_{S}, sends the wrapped source encrypt key K_{S} and the confidential data (including the secret 1304 and the configuration settings 1305) to the authenticator 320. In certain embodiments, the communication at operation 1320 is defined as “secret, wrappedPrivKey_A.”

At block 1322, the authenticator 320 unwraps the wrapped private key K_{S} using a device root key, which can be defined as “DRKPrivKey_A=unwrap(wrappedPrivKey_A)”.

At block 1324, the authenticator 320 splits the secret 1304 into N shares according to the configuration setting 1305. The processes performed at block 1324 and at block 607 of FIG. 6 are similar, and a duplicative description is not provided here. In certain embodiments, splitting the secret into N shares includes wrapping N shares. The processor 340 receives and stores the N wrapped shares 1326 in the database storage 336.

Now refer to FIG. 13B, which illustrates a continuation of the process 1300. From among the configuration settings 1305, the processor 340 accesses a user selection 1328 (similar to user selections 818a-818c of FIG. 8B) regarding visibility for an individual one of the N shares, and determines if visibility for the share is set to one binary value (e.g., true (T)), then the user of the trustee device 102 will be able to see the share. However, if visibility is set the other binary value (e.g., false (F)), then the user of the trustee device 102 will not be able to see the share, and the encryption of the share will be such that none of the trustee devices can access the secret by decrypting the secret share transferred to the trustee device. The user selection 1328 regarding visibility corresponds to the Share₁ that is assigned to the trustee device 102. Other shares can be labeled with an index (i) that has the values 1 though N for each of the shares Share_{i=1 . . . N}.

At operation 1330, the processor 340 sends (to the authenticator 320) the wrapped Share₁ 1332 assigned to the trustee device 102, the user selection 1328 regarding visibility of the Share₁, and a trustee certificate 1334 corresponding to the trustee device 102. As an example, a trustee certificate 1334 can be defined as “DRKCert_B” and based on the encrypt key K_{T} 1334.

At block 1336, the authenticator 320 generates a request 1338 (“Req.”), which can be defined as “req=jws(ID_A, jwe(share∥visibility, DRKPubKey_B), DRKPrivKey_A).” The request 1338 includes the Share₁ and the user selection 1328 regarding visibility of Share₁, both of which are encrypted using a trustee public key (DRKPubKey_B) that is derived from the private trustee encrypt key K_{T}, and both of which are again (e.g., doubly) encrypted using the source encrypt key K_{S}. That is, the double encryption (also referred to as “dual encryption”) of this disclosure is distinct from a single encryption based on two encryption keys, as the dual encryption of this disclosure includes two authentications (e.g., biometric authentications), which includes an authentication by the owner and an authentication by the trustee. This disclosure is not limited to a single order of double encryption, and it is understood that double encryption of the Share₁ can include an initial encryption using the source encrypt key K_{S} followed by an encryption using the trustee public key (DRKPubKey_B). The request 1338 includes an identifier (illustrated as “ID_A”) of the source electronic device 101, which identifier is encrypted using the source encrypt key K_{S}. The request 1338 includes a signature that could be generated using a JSON web signature function (jws( )) based on the Share, visibility settings, and the private source encrypt key K_{S}. In sum, the request 1338 includes: the secret share which is doubly encrypted using source encrypt key K_{S} and a communication encryption key K_{C}.

The authenticator 320 sends the request 1338 to the processor 340, which transmits the request 1338 to the TEE 602 of the trustee device via a short-range communication 1340 (for example, a tap). The request 1338 is configured to cause the trustee device 102 to store the share (Share) in the storage 636 of the TEE 602 of the trustee device, but trustee TEE 602 performs various operations 1342-1346 before storing the received share in the storage 636.

At block 1342, in response to receiving the request 1338, the trustee TEE 602 checks whether the received Share₁ is secure. In certain embodiments, checking whether the received share is secure includes determining whether the identifier of the source device 101 was previously set at the trustor, and if not (e.g., “A.isTrustor=false”), rejecting the received share and determining the received share is not secure. In certain embodiments, checking whether the received share is secure includes determining whether the source device transmitted too much data via the communication 1340, and if so, rejecting the received share and determining the received share is not secure. Similarly, trustee TEE 602 accepts the received share based on a determination that the identifier of the source device 101 was previously set as the trustor (e.g., “A.isTrustor=true”) and that the source device 101 did not transmit too much data.

In response to identifying (at block 1344) that a source certification (“DRKCert_A”) 1427 was previously stored in the trustee storage 636, the trustee TEE 602 checks (at block 1346) the (“jws”) signature. For example, at block 1346, checking the signature could include decrypting and verifying the doubly encrypted signature (e.g., jws signature which was received via the communication 1340).

At operation 1348, the trustee TEE 602 sends the request 1338 and the wrapped encrypt key K_{T} 1350 to the trustee authenticator 320_{T}. In certain embodiments, the communication a operation 1348 could be defined as “req, wrappedPrivKey_B.”

Now refer to FIG. 13C, which illustrates a continuation of the process 1300. At block 1352, the trustee authenticator 320_{T} unwraps the wrapped trustee encrypt key K_{T}. In certain embodiments, the unwrapping at block 1352 can be defined as “DRKPrivKey_B=unwrap(wrappedPrivKey_B).”

At block 1354, the trustee authenticator 320_{T} decrypts the share Shareᵢ using the unwrapped trustee encrypt key K_{T}, which in certain embodiments is defined as “DRKprivKey_B.”

At block 1356, the trustee authenticator 320_{T} wraps the share (i.e., Share). As an example, the wrapped Share, 1364 can be defined as “wrappedShare=wrap(share).”

At block 1358, the trustee authenticator 320_{T} generates an acknowledgement 1360, which can be defined as “ack=jws(OK, DRKPrivKey_B).” That is, the acknowledgement 1360 is generated based on the unwrapped trustee encrypt key K_{T}.

At operation 1362, the trustee authenticator 320_{T} sends the acknowledgement 1360 and the wrapped Shareᵢ 1364 to the trustee TEE 602.

At block 1366, the trustee TEE 602 stores (e.g., saves), in the storage 363 of the trustee TEE 602, the following: the wrapped Share, 1364, the user selection 1328 regarding visibility corresponds to the wrapped Share₁ 1364, and the identifier (e.g., “ID_A”) of the source electronic device 101.

At operation 1368, the trustee TEE 602 transmits the acknowledgement 136 and the identifier (“ID_B”) of trustee electronic device 102 to the processor 340 of TEE 302 of the source electronic device 101 via a short-range communication. For example, the transmission performed at operation 1368 can be defined as “ACK∥ID_B.”

In response to identifying (at block 1370) that trustee certificate (“DRKCert_B”) 1334 was previously stored in the source storage 336, the processor 340 of the source device verifies (at block 1372) the (“jws”) signature. For example, at block 1372, checking the signature could include decrypting and verifying the signature defined by the acknowledgement 1360 (e.g., defined as “ack=jws(OK,DRKrivKey_B)”).

At block 1374, the processor 340 of the source device determines whether to send another share or to complete the D2D secret backup process 1300. More particularly, the processor 340 determines whether all N shares have been transmitted to a plurality of N trustee devices, and if not, the processor 340 transmits another share (e.g., Share₂) to another trustee device (such as the third electronic device 104), but if so, the process 1300 ends.

FIG. 14 illustrates a process 1400 for securely pairing a source electronic device 101 to a trustee electronic device 102 in accordance with an embodiment of this disclosure. It is understood that the process 1400 is performed by the processor 340 of the TEE 302 of the source electronic device 101 in collaboration with the TEE 602 of a trustee electronic device 102. In the process 1400, the source and trustee electronic devices 101 and 102 communicate via short-range D2D communication and securely pair with a key negotiated between the respective TEEs 302 and 602, as described more particularly below. FIG. 14 shows a generic authenticator 1412 that is similar to the generic authenticator 1314 of FIG. 13. That is, the generic authenticator 1412 can represent the authenticator 320_{T} of the trustee device or the authentication service provided by the server 106, but the process 1400 will be described in terms of the authenticator 320_{T} performing (at block 1434) user authentication processes.

The process 1400 begins when the source electronic device 101 obtains an add trustee message 1402 (illustrated as “msg=add trustee∥add trustor”) indicating that the user of the source electronic device 101 has selected to add a trustee electronic device 102. Obtaining the add trustee message 1402 can be performed by using the processor 340 to generate the message 1402, or by receiving the message 1402 from a user interface (UI 306 or trusted UI 310).

In the process 1400, user authentication is required at the beginning of device paring, as such, the processor 340 sends a user authentication request 1406 which includes user credentials 1408, to the authenticator 320. The processes performed at block 1410 and at block 1316 of FIG. 13 are similar, and a duplicative description is not provided here. Based on the results of the user authentication (at block 1410), the authenticator 320 sends an acknowledgement 1414 or an error signal to the processor 340.

As operation 1416, the processor 320, in response to receiving the acknowledgement 1414, generates a source encrypt key K_{S} from the credentials C, wraps the source encrypt key K_{S}, and forwards the add trustee message 1402 and the wrapped K_{S} to the authenticator 320. The forwarding communication from the processor 320 to the authenticator 320 is illustrated is as “msg, wrappedPrivKey_A.”

At operation 1418, the authenticator 320 accesses the source encrypt key K_{S} by unwrapping the wrapped source encrypt key K_{S}, for example, illustrated as “DRKPrivKey_A=unwrap(wrap(wrappedPrivKey_A)”.

The authenticator 320 generates a signature 1420 using the source encrypt key K_{S}. For example, the signature 1420, which is illustrated as req=jws(msg, DRKPrivKey_A), could be generated using a JSON web signature function (jws( )) based on the add trustee message 1402 (“msg”) and the wrapped source encrypt key K_{S}.

At operation 1422, the processor 340 receives the signature 1420 (“req”) from the authenticator 320.

At operation 1424, the processor 340 detects that the source electronic device 101 has moved into a location in close proximity to the trustee device 102 (illustrated as a 1^{st} tap). For example, the back surface of each of the two devices 101 and 102 may face each other, and may contact (e.g., tap) each other. While the source and trustee electronic devices 101 and 102 are located in close proximity to each other (e.g., during the first tap), the processor 340 of the source electronic device 101 negotiates a communication encrypt key K_{C} and transmits a signal (illustrated as “req∥DRKCert_A”) to the TEE 602 of the trustee device 102. That is, the processor 340 transmits the signature 1420, which includes a source certification (“DRKCert_A”).

At operations 1426-1450, the source and trustee devices 101 and 102 may be moved and separated away from close proximity to each other. At operation 1426, the TEE 602 verifies the source certificate 1427 (illustrated as “DRKCert_A”). Additionally at operation 1426, the TEE 602 ascertains an identifier 1429 (“ID_A”) of the source/recovery device 101 (for example, by performing a “get ID_A” function).

At operation 1428, the TEE 602 checks the jws signature, namely, the signature 1420.

At operation 1430, the TEE 602 confirms whether the trustee device 102 is a trustee or a trustor in a relationship with the source electronic device 101.

At operation 1432, the TEE 602 sends a user authentication request, which includes user consent 1436, to the trustee authenticator 320_{T} or 1412. For example, the user (e.g., Nancy) of the trustee device 102 may input a selection indicating consent 1436 for the user's electronic device 102 to be added as trustee in a relationship with source device 101 as trustor.

At operation 1434, the trustee authenticator 1412 performs user authentication processes. For example, the trustee authenticator 1412 determines whether the received user consent 1436 were received from the owner of the trustee electronic device 102 by comparing the user credentials 1310 to a credential CT previously registered into the TEE 602 by the owner/user of the trustee electronic device 102. Based on the results of the user authentication, the trustee authenticator 1412 sends an acknowledgement 1438 or an error signal to the TEE 602. In certain embodiments, during the pairing process, the TEE 602 of the trustee device computes and stores a hash of the biometric data of the owner of the secret in the secure storage 636 of trustee device 102.

At operation 1440 (illustrated as “Add ID_A∥DRKCert_A, set A.isTrustor=true, A.isTrustee=true”), the trustee TEE 602, in response to receiving the acknowledgement 1438, sets the identifier (illustrated as “ID_A) of source device 101 as the trustor (illustrated as “set A.isTrustor=true”).

At operation 1442, the trustee TEE 602 generates, wraps, and stores a trustee encrypt key K_{T} in trusted database storage 636. The trustee TEE 602 sends an acknowledgement (illustrated as genAck(“yes”, wrappedPrivKey_B)”) to the trustee authenticator 320_{T}. The acknowledgement includes the wrapped trustee encrypt key K_{T}.

At operation 1444, the trustee authenticator 320_{T} accesses the trustee encrypt key K_{T} by unwrapping the wrapped trustee encrypt key K_{T}, for example, illustrated as “DRKPrivKey_B=unwrap(wrappedPrivKey_B).”

At operation 1446, the trustee authenticator 320_{T} generates a signature 1448 using the trustee encrypt key K_{T}. For example, the signature 1448, which is illustrated as ack=jws(“yes”, DRKPrivKey_B), could be generated using a JSON web signature function (jws( )) based on the message (“yes”) and the wrapped trustee encrypt key K_{T}. The trustee authenticator 320_{T} sends an acknowledgement 1450, including the signature 1448, to the trustee TEE 602.

At operation 1452, the trustee TEE 602 detects that the source electronic device 101 has moved into a location in close proximity to the trustee device 102 (illustrated as a 2^{nd} tap). During the second tap, the trustee TEE 602 a transmits the signature 1448 via a signal (illustrated as “ack∥DRKCert_B”) to the TEE 304 of the source device 101, and the signal includes the trustee encrypt key K_{T}.

At operation 1454, the processor 340 verifies the trustee encrypt key K_{T}. At operation 1456, the processor 340 verifies the signature 1448. At operation 1458 (illustrated as “add ID_B∥DRKCert_B, set B.isTrustee=true, B.isTrustor=true”), the processor 340 sets the identifier (illustrated as “ID_B”) of trustee device 102 as the trustor (illustrated as “set B.isTrustee=true”). The process 1400 ends upon completion of operation 1458. Although FIG. 14 shows one example of source device 101 setting itself as trustor and setting the second electronic device 102 as trustee, it is understood that that in another iteration of the process 1400, the second electronic device 102 can function as a source device and can set itself as trustor and set the first electronic device 101 as trustee.

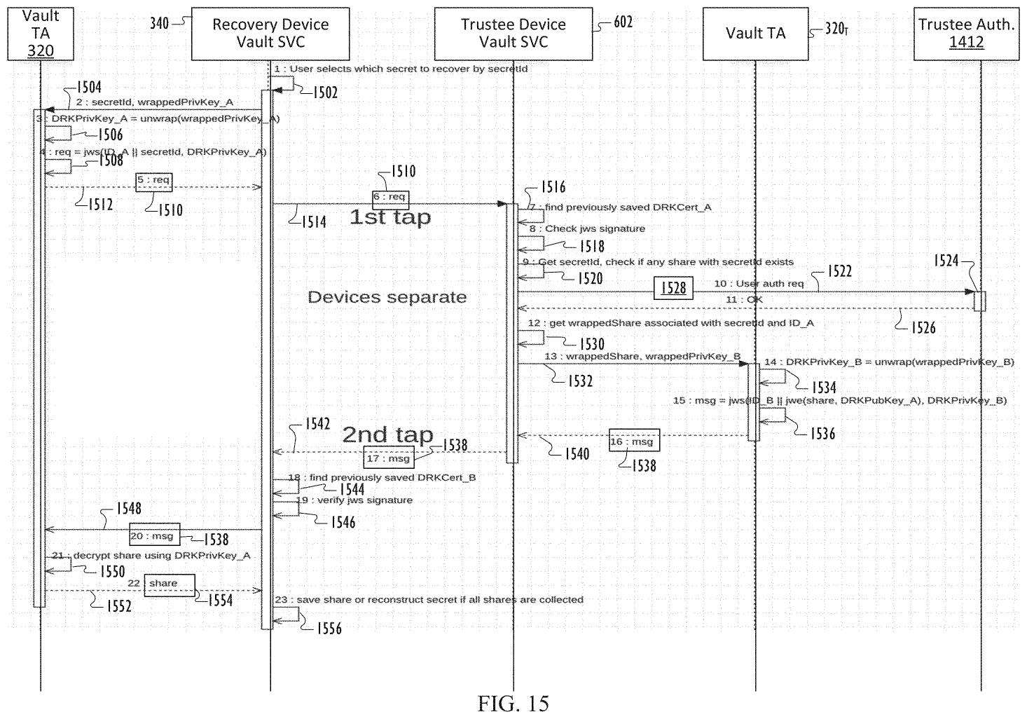

FIG. 15 illustrates a process 1500 for device-to-device secret recovery in accordance with an embodiment of this disclosure.

At operation 1502, the user of the recovery device 101 selects which secret to recover by selecting an identifier (illustrated as “secretID”) of the selected secret. More particularly, the processor 340 of the recovery device 101 receives input indicating the identifier (“secretID”) of the selected secret.

At operation 1504, the processor 340 of the recovery device 101 sends, to the trusted authenticator 320 of the recovery device 101, the following: the identifier (“secretID”) of the selected secret and the wrapped source encrypt key K_{S} (illustrated as “wrappedPrivKey_A”).

At operation 1506, the trusted authenticator 320 unwraps the wrapped source encrypt key K_{S}. The function performed at operation 1506 can be defined as “DRKPrivKey_A=unwrap(wrappedPrivKey_A).”

At operation 1508, the trusted authenticator 320 generates a request (“req”) 1510, which can be defined as “req=jws(ID AH secretID, DRKPrivKey_A).”

At operation 1512, the trusted authenticator 320 sends the request 1510 to the processor 340 of the TEE 302.

At operation 1514, the processor 340 detects that the recovery electronic device 101 has moved into a location in close proximity to the trustee device 102 (illustrated as a 1^{st} tap). During the first tap, the processor 340 forwards the request 1510 to the TEE 602 of the trustee device 102 via a short-range communication.

The processes performed at operations 1516 and 1518 are similar the processes performed at blocks 1344 and 1346 of FIG. 13, and a duplicative description is not provided here.

At operation 1520, the TEE 302 searches for the identifier (“secretID”) of the selected secret in the database 636, and checks whether the database 636 contains any share that is related to the identifier of the selected secret.

The processes performed at operations 1522, 1524, and 1526 are similar the processes performed at operations 1432, 1434, and 1438 of FIG. 14, and a duplicative description is not provided here. At operation 1522, the user authentication request, which includes user credentials 1528 of the user (e.g., Nancy) of the trustee device 102. The user credentials 1528 of a trustee, and the user credentials 1408 input to the recovery device 101 by the owner of the secret to be recovered, can include biometric information.

At operation 1530, the trustee TEE 602 retrieves, from the database 636, a share that is related to both the identifier (“secretID”) of the selected secret and the identifier (“ID_A) of source device 101. The retrieved share is wrapped (illustrated as “wrappedShare”). In the embodiment shown in FIG. 15, the configuration settings are set such that the identifier (“secretID”) of the selected secret is only known by the source device that sent the share of the selected secret to the trustee device. That is, in the embodiment shown, only the source electronic device 101 can be the recovery device, and as a result, the identifier (“ID_A) identities the source device 101 and the recovery device 101.

At operation 1532, the trustee TEE 602 sends the wrappedShare and the wrapped trustee encrypt key K_{T} to the trustee authenticator 320_{T}. The wrapped trustee encrypt key K_{T} is illustrated as “wrappedPrivKey_B.”

The process performed at operation 1534 is similar the process performed at blocks 1444 of FIG. 14, and a duplicative description is not provided here.

At operation 1536, the authenticator 320 generates a message 1538 (“msg”), which can be defined as “msg=jws(ID_B jwe(share, DRKPubKey_A), DRKPrivKey_B).” The message 1538 includes a signature that could be generated using a JSON web signature function (jws( )) based on the Share, and the identifier (“ID_B”) of the trustee device, and a trustee private key (“DRKPrivKey_B”). The message 1538 includes the Share₁, which is encrypted using a source public key (DRKPubKey_A).

At operation 1540, the trustee authenticator 320_{T} sends the message 1538 to the trustee TEE 602, which forwards (at operation 1542) the message 1538 to the TEE 302 of the recovery device 101. That is, at operation 1542, the trustee TEE 602 detects that the recovery electronic device 101 has moved into a location in close proximity to the trustee device 102 (illustrated as a 2^{nd} tap). During the second tap, the trustee TEE 602 a transmits the message 1538 to the TEE 302 via short-range communications.

The processes performed at operations 1544 and 1546 are similar the processes performed at blocks 1370 and 1372 of FIG. 13, and a duplicative description is not provided here.

At operation 1548, the trustee TEE 602 sends the message 1538 to the authenticator 320 of the recovery device 101. At operation 1550, the authenticator 320 of the recovery device 101 decrypts the retrieved share using the private key DRKPrivKey_A, which was received within the message 1538. At operation 1552, after the share has been decrypted, the authenticator 320 sends the decrypted share 1544 to the processor 340 the TEE 340 of the recovery device 101.

At operation 1556, the processor 340 saves the retrieved share 1554 in the storage 336 of the recovery device 101. Additionally at operation 1556, the processor 340 determines whether K shares have been retrieved from to a subset of K trustee devices, and if not, the processor 340 retrieves another share (e.g., Share₂) from another trustee device (such as the third electronic device 104). If the processor 340 determines K shares have been retrieved, then the processor 340 reconstructs the secret from K retrieved shares using a selected algorithm, and process 1400 ends.

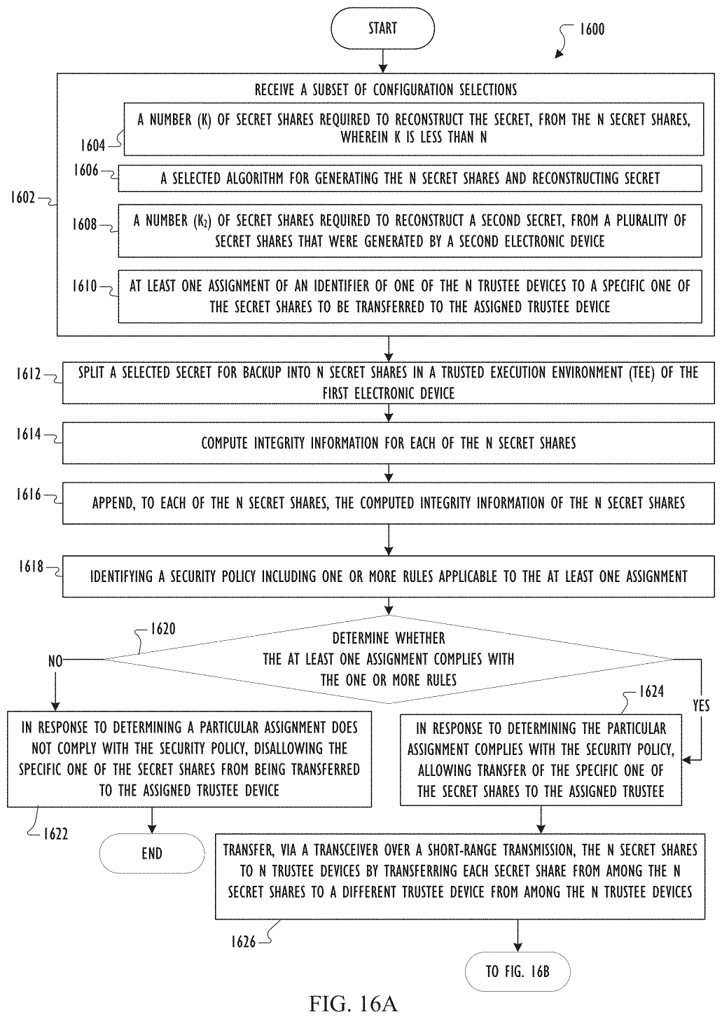

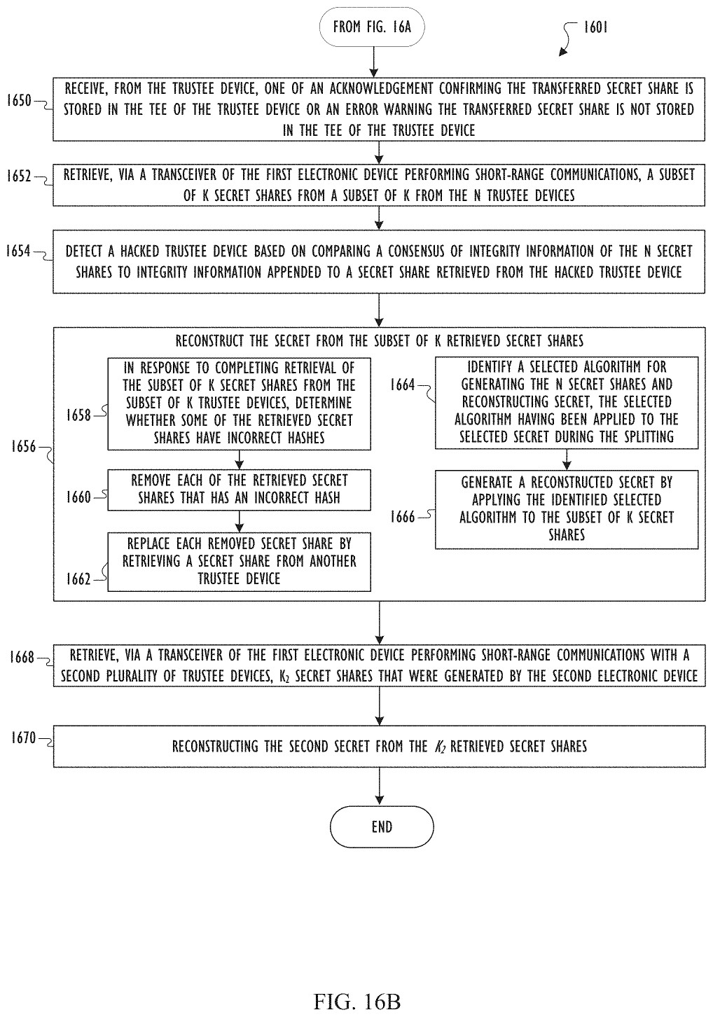

FIGS. 16A-16B (FIG. 16) illustrate methods of operating a first electronic device for device-to-device secret backup and recovery, in accordance with an embodiment of this disclosure. FIG. 16A illustrates the method 1600 of device-to-device secret backup. FIG. 16B illustrates the method 1601 of device-to-device secret recovery. For ease of explanation, the methods 1600-1601 shown in FIG. 16 is described as being performed by processor 120 of the first electronic device 101 shown in FIG. 1, executing the secret vault app 263 of FIG. 2. However, the methods 1600-1601 shown in FIG. 16 could be implemented by any other suitable electronic device (such as any of the electronic devices 102 or 104) and in any suitable system.

Now refer to FIG. 16A. At block 1602, the processor 120 receives a subset of configuration selections. As shown by block 1604, in certain embodiments, subset of configuration selections includes a number (K) of secret shares required to reconstruct the secret, from the N secret shares. K is less than N. As shown by block 1606, in certain embodiments, subset of configuration selections includes a selected algorithm for generating the N secret shares and reconstructing the secret. As shown by block 1608, in certain embodiments, subset of configuration selections includes a number (K₂) of secret shares required to reconstruct a second secret, from a plurality of secret shares that were generated by a second electronic device (e.g., another electronic device 102 or 104 that assigned the first electronic device 101 as a trustee device). As shown by block 1610, in certain embodiments, subset of configuration selections includes at least one assignment of an identifier of one of the N trustee devices to a specific one of the secret shares to be transferred to the assigned trustee device.

At block 1612, the processor 120 splits a selected secret for backup into N secret shares in a trusted execution environment (TEE) 302 of the first electronic device 101. At block 1614, the processor 120 computes integrity information for each of the N secret shares. At block 1616, the processor 120 appends, to each of the N secret shares, the computed integrity information of the N secret shares.

At block 1618, the processor 120 identifies a security policy including one or more rules applicable to the at least one assignment. At block 1620, the processor 120 determines whether the at least one assignment complies with the one or more rules. At block 1622, in response to determining a particular assignment does not comply with the security policy, the processor 120 disallows the specific one of the secret shares from being transferred to the assigned trustee device, and the method 1600 ends. At block 1624, in response to determining the particular assignment complies with the security policy, the processor 120 allows transfer of the specific one of the secret shares to the assigned trustee. At block 1626, the processor 120 transfers the N secret shares to N trustee devices via a transceiver (e.g., 170) over a short-range transmission (e.g., 615 of FIG. 6) by transferring each secret share from among the N secret shares to a different trustee device from among the N trustee devices.

Now refer to FIG. 16B, in which the processor 120 performs device-to-device secret recovery. At block 1650, the processor 120 receives, from the trustee device, one of an acknowledgement confirming the transferred secret share is stored in the TEE of the trustee device or an error warning the transferred secret share is not stored in the TEE of the trustee device. That is, the processor 120 receives an acknowledgement or an error warning, but not both. At block 1652, the processor 120 retrieves, via a transceiver of the first electronic device performing short-range communications, a subset of K secret shares from a subset of K from the N trustee devices. That is, K trustee devices send K secret shares to the first electronic device using short-range communications. At block 1654, the processor 120 detects a hacked trustee device based on comparing a consensus of integrity information of the N secret shares to integrity information appended to a secret share retrieved from the hacked trustee device.

At block 1656, the processor 120 reconstructs the secret from the subset of K retrieved secret shares. In certain embodiments, reconstructing (as shown by blocks 1656-1666) the secret from K retrieved secret shares includes determining (at block 1658), in response to completing retrieval of the subset of K secret shares from the subset of K trustee devices, whether some of the retrieved secret shares have incorrect hashes. At block 1660, the processor 120 removes each of the retrieved secret shares that has an incorrect hash. At block 1662, the processor 120 replace each removed secret share by retrieving a secret share from another trustee device. In certain embodiments, reconstructing (as shown by blocks 1664-1666) the secret from K retrieved secret shares includes identifying (at block 1664) a selected algorithm for generating the N secret shares and reconstructing the secret. The selected algorithm has been applied to the selected secret during the splitting. At block 1666, the processor 120 generates a reconstructed secret by applying the identified selected algorithm to the subset of K secret shares.

The first electronic device 101 is not limited to recovering only one secret share. In blocks 1668-1670, first electronic device 101 recovers a second secret. At block 1668, the processor 120 retrieves, via a transceiver of the first electronic device performing short-range communications with a second plurality of trustee devices, K₂ secret shares that were generated (at block 1608 of FIG. 16A) by the second electronic device. For example, the second plurality of trustee devices represent Nicole's smartphone and Renee's smartphone, similar to the electronic devices 102 and 104. At block 1670, the processor 120 reconstructs the second secret from the K₂ retrieved secret shares.

The electronic device 101 is not limited to performing the functions of a trustor device that splits and reconstructs secrets, rather it is understood that electronic device 101 can also perform the functions of a trustee device.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of electronic devices, various changes may be made to the figures. For example, the electronic devices can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the applicants to refer to structures known to those skilled in the relevant art and is not intended to invoke 35 U.S.C. § 112(f).

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method executed by a first electronic device, the method comprising:
splitting a selected secret for backup into N secret shares in a trusted execution environment (TEE) of the first electronic device;
transferring, via a transceiver over a short-range transmission, the N secret shares to N trustee devices, by transferring each secret share from among the N secret shares to a different trustee device from among the N trustee devices,
wherein each secret share is configured to, when received by a trustee device, cause the trustee device to store the secret share in a TEE of the trustee device; and
receiving, from the trustee device, one of an acknowledgement confirming the transferred secret share is stored in the TEE of the trustee device or an error warning the transferred secret share is not stored in the TEE of the trustee device.

2. The method of claim 1, further comprising:
computing integrity information for each of the N secret shares;
appending, to each of the N secret shares, the computed integrity information of the N secret shares; and
detecting a hacked trustee device based on comparing a consensus of integrity information of the N secret shares to integrity information appended to a secret share retrieved from the hacked trustee device.

3. The method of claim 1, further comprising:
receiving a subset of configuration selections that include a number (K) of secret shares required to reconstruct the secret, from the N secret shares, wherein K is less than N.

4. The method of claim 3, further comprising:
retrieving, via a transceiver of the first electronic device performing short-range communications, a subset of K secret shares from a subset of K from the N trustee devices; and
reconstructing the secret from the subset of K retrieved secret shares.

5. The method of claim 4, wherein reconstructing the secret from the subset of K retrieved secret shares comprises:
in response to completing retrieval of the subset of K secret shares from the subset of K trustee devices, determining whether some of the retrieved secret shares have incorrect hashes;
removing each of the retrieved secret shares that has an incorrect hash; and
replacing each removed secret share by retrieving a secret share from another trustee device.

6. The method of claim 4, wherein reconstructing the secret comprises:
identifying a selected algorithm for generating the N secret shares and reconstructing the secret, the selected algorithm having been applied to the selected secret during the splitting; and
generating a reconstructed secret by applying the identified selected algorithm to the subset of K secret shares.

7. The method of claim 3, further comprising:
receiving a subset of configuration selections that includes a selected algorithm for generating the N secret shares and reconstructing the secret, wherein the selected algorithm supports:
backup of the secret to up to the N trustee devices;
any subset of K trustee devices can reconstruct the secret from K secret shares;
fewer than K trustee devices cannot reconstruct of the secret; and
encryption of the N secret shares such that none of the trustee devices can access the secret by decrypting the secret share transferred to the trustee device.

8. The method of claim 1, further comprising:
receiving a subset of configuration selections that include a number (K₂) of secret shares required to reconstruct a second secret, from a plurality of secret shares that were generated by a second electronic device;
retrieving, via a transceiver of the first electronic device performing short-range communications with a second plurality of trustee devices, K₂ secret shares that were generated by the second electronic device; and
reconstructing the second secret from the K₂ retrieved secret shares.

9. The method of claim 1, further comprising:
receiving a subset of configuration selections that includes: at least one assignment of an identifier of one of the N trustee devices to a specific one of the secret shares to be transferred to the assigned trustee device.

10. The method of claim 9, further comprising:
identifying a security policy including one or more rules applicable to the at least one assignment;
determining whether the at least one assignment complies with the one or more rules;
in response to determining a particular assignment does not comply with the security policy, disallowing the specific one of the secret shares from being transferred to the assigned trustee device;
in response to determining the particular assignment complies with the security policy, allowing transfer of the specific one of the secret shares to the assigned trustee device.

11. A first electronic device comprising:
a transceiver configured to perform short-range communications;
a processor coupled to the transceiver and to a memory; and
the memory storing instructions that, when executed by the processor, cause the processor to:
split a selected secret for backup into N secret shares in a trusted execution environment (TEE) of the first electronic device;
transfer, via the transceiver over a short-range transmission, the N secret shares to N trustee devices, by transferring each secret share from among the N secret shares to a different trustee device from among the N trustee devices,
wherein each secret share is configured to, when received by a trustee device, cause the trustee device to store the secret share in a TEE of the trustee device; and
receive, from the trustee device, one of an acknowledgement (ACK) confirming the transferred secret share is stored in the TEE of the trustee device or an error warning the transferred secret share is not stored in the TEE of the trustee device.

12. The first electronic device of claim 11, wherein the instructions cause the processor to:
compute integrity information for each of the N secret shares;
append, to each of the N secret shares, the computed integrity information of the N secret shares; and
detect a hacked trustee device based on comparing a consensus of integrity information of the N secret shares to integrity information appended to a secret share retrieved from the hacked trustee device.

13. The first electronic device of claim 11, further comprising a display configured to display a user interface on a screen, the display operably coupled to the processor, and wherein the instructions cause the processor to:
receive, via the user interface, user input indicating a subset of configuration selections that include a number (K) of secret shares required to reconstruct the secret, from the plurality of secret shares, wherein K is less than N.

14. The first electronic device of claim 13, wherein the instructions cause the processor to:
retrieve, via short-range communications, a subset of K secret shares from a subset of K from the N trustee devices; and
reconstruct the secret from the subset of K retrieved secret shares.

15. The first electronic device of claim 14, wherein reconstructing the secret from the subset of K retrieved secret shares comprises:
in response to completing retrieval of the subset of K secret shares from the subset of K trustee devices, determining whether some of the retrieved secret shares have incorrect hashes;
removing each of the N secret shares that has an incorrect hash; and
replacing each removed secret share by retrieving a secret share from another trustee device.

16. The first electronic device of claim 14, wherein reconstructing the secret comprises:
identifying a selected algorithm for generating the N secret shares and reconstructing the secret, the selected algorithm having been applied to the selected secret during the splitting; and
generating a reconstructed secret by applying the identified selected algorithm to the subset of K secret shares.

17. The first electronic device of claim 13, further comprising a display configured to display a user interface on a screen, the display operably coupled to the processor, and wherein the instructions cause the processor to:
receive, via the user interface, user input indicating a subset of configuration selections that includes a selected algorithm for generating the N secret shares and reconstructing the secret, wherein the selected algorithm supports:
backup of the secret to up to N trustee devices;
any subset of K trustee devices can reconstruct the secret from K secret shares;
fewer than K trustee devices cannot reconstruct of the secret; and
encryption of the N secret shares such that none of the trustee devices can access the secret by decrypting the secret share transferred to the trustee device.

18. The first electronic device of claim 11, further comprising a display configured to display a user interface on a screen, the display operably coupled to the processor, and wherein the instructions cause the processor to:
receive, via the user interface, user input indicating a subset of configuration selections that include a number (K₂) of secret shares required to reconstruct a second secret, from a plurality of secret shares that were generated by a second electronic device;
retrieve, via short-range communications with a second plurality of trustee devices, K₂ secret shares that were generated by the second electronic device; and
reconstruct the second secret from the K₂ retrieved secret shares.

19. The first electronic device of claim 11, further comprising a display configured to display a user interface on a screen, the display operably coupled to the processor, and wherein the instructions cause the processor to:
receive, via the user interface, user input indicating a subset of configuration selections that includes: at least one assignment of an identifier of one of the N trustee devices to a specific one of the secret shares to be transferred to the assigned trustee device.

20. The first electronic device of claim 19, wherein the instructions cause the processor to:
identify a security policy including one or more rules applicable to the at least one assignment;
determine whether the at least one assignment complies with the one or more rules;
in response to determining a particular assignment does not comply with the security policy, disallow the specific one of the secret shares from being transferred to the assigned trustee device;
in response to determining the particular assignment complies with the security policy, allow transfer of the specific one of the secret shares to the assigned trustee device.

21. A trustee electronic device comprising:
a transceiver configured to perform short-range communications;
a processor coupled to the transceiver and to a memory;
the memory storing instructions that, when executed by the processor, cause the processor to:
establish a short-range communications connection to a source electronic device;
receive a secret share from a trusted execution environment (TEE) of the source electronic device over the short-range communication connection, the secret share being one from among N secret shares generated by the source electronic device;
check whether the received secret share is secure;
in response to determining the received secret share is secure, store the secret share in a TEE of the trustee electronic device and transmit an acknowledgement to the source electronic device confirming the received secret share is stored in the TEE of the trustee electronic device; and
in response to determining the received secret share is not secure, transmit an error signal to the source electronic device warning the received secret share is not stored in the TEE of the trustee electronic device.

22. The trustee electronic device of claim 21, wherein the instructions cause the processor to:
receive, from a recovery electronic device, a request to transfer the secret share to the recovery electronic device, wherein the request contains an identifier of the source electronic device;
establish a short-range communications connection to the recovery electronic device; and
transfer, to the recovery electronic device, the secret share corresponding to the identifier of the source electronic device.
